(19) United States
(12) Patent Application Publication
(10) Pub. No.: US 2005/0163659 A1
(43) Pub. Date: Jul. 28, 2005

(54) Kit for assay development and serial analysis

(75) Inventors: Gert Ludwig Duveneck, Bad Krozingen (DE); Peter Oroszlan, Basel (CH); Michael Pawlak, Laufenburg (DE)

Correspondence Address: WENDEROTH, LIND & PONACK, L.L.P., 2033 K STREET N. W., SUITE 800, WASHINGTON, DC, 20006-1021, US

(73) Assignee: Zeptosens AG, Witterswil (CH)

(21) Appl. No.: 10/514,166

(22) PCT Filed: May 6, 2003
(86) PCT No.: PCT/EP03/04717

(30) Foreign Application Priority Data
May 13, 2002 (CH) 791/02

(51) Int. Cl. G01N 21/00

(52) U.S. Cl. 422/61; 422/82.05

(57) ABSTRACT

The invention relates to a kit for assay development and for carrying out a plurality of analyses, comprising a carrier substrate and a placement body jointly forming an arrangement of a plurality of sample compartments comprising said carrier substrate as a base plate, in addition to a plurality of immobilized binding partners for the detection of one or more analytes in one or more samples in a bioaffinity assay, said binding partners being arranged and immobilized on the carrier substrate inside the sample containers always in two-dimensional arrays of discrete measuring areas, wherein always at least one measuring area of an array or a partial surface inside an array or sample compartment, respectively, is provided on the carrier substrate for referencing purposes, and the surface density of the immobilized binding partners, in relation to the surface of the measurement areas, is less than the surface density of a full, i.e. extensive, monolayer of said binding partners. The composition of the inventive kit is such that, surprisingly, it enables a full series of measurements to be carried out on an individual carrier substrate. The invention also relates to an analytical system wherein the inventive kit is used, and to analytical detection methods based thereon and the use thereof.

The invention relates to a kit for assay development and for carrying out a plurality of analyses, comprising:
a carrier substrate and
a placement body
   jointly forming an arrangement of a plurality of sample compartments comprising said carrier substrate as a base plate, in addition to
a plurality of immobilized binding partners for the detection of one or more analytes in one or more samples in a bioaffinity assay, said binding partners being arranged and immobilized on the carrier substrate inside the sample compartments always in two-dimensional arrays of discrete measuring areas,
   wherein
always at least one measuring area of an array or a partial surface inside an array or sample compartment, respectively, is provided on the carrier substrate for referencing purposes, and
   the surface density of the immobilized binding partners, in relation to the surface of the measurement areas, is less than the surface density of a full, i.e. extensive, monolayer of said binding partners.

This composition of the inventive kit is such that, surprisingly, it enables a full series of measurements to be carried out on an individual carrier substrate.

The invention also relates to an analytical system wherein the inventive kit is used, and to analytical detection methods based thereon and the use thereof.

For the determination of a plurality of analytes or analysis of a plurality of samples, methods in widespread use at present, in particular in industrial analytical laboratories, are in particular those in which different analytes are determined in discrete sample compartments or “wells” of so-called microtiter plates. The plates most widely used here are those featuring 8×12 wells on a footprint of typically about 8 cm×12 cm, wherein a volume of some hundred microliters is required for filling a single well. It would be desirable for many applications, however, to determine several analytes simultaneously in a single sample compartment, using a sample volume as small as possible.

In U.S. Pat. No. 5,747,274, measurement arrangements and methods for the early detection of a myocardial infarction by determining several of at least three infarction markers are described, wherein the determination of these markers may be performed in individual sample containers or in a common sample container wherein—as described in the disclosure for the latter case—a single sample container is provided as a continuous flow channel, one demarcation area of which forms a membrane, for example, whereon antibodies for the three different markers are immobilized. However, there is no indication to suggest an arrangement of several such sample containers or flow channels on a common substrate. Furthermore, there is no geometric information with regard to the size of the measurement areas.

In WO 84/01031, U.S. Pat. No. 5,807,755, U.S. Pat. No. 5,837,551, and U.S. Pat. No. 5,432,099, immobilization of specific recognition elements for an analyte in the form of small “spots”, some of which have an area significantly less than 1 mm², on solid substrates is proposed. The purpose of this immobilization geometry is, by binding only a small part of the analyte molecules present, to enable the concentration of an analyte to be determined in a manner which is only dependent on incubation time and (in the absence of a continuous flow) is essentially independent of the absolute sample volume. The measurement arrangements disclosed in the examples are based on fluorescence measurements in conventional microtiter plates. Arrangements are also described here in which spots of up to three different, fluorescently labeled antibodies are measured in a common microtiter plate well. According to the theory set forth in these patent specifications, a minimization of the spot size would be desirable. However, the minimum signal height distinguishable from the background signal would have a limiting effect on the spot size.

However, no indications towards a referencing of the measured signals, within arrays, are given in the cited patent disclosures.

Besides numerous other arrangements for the design of sample compartments for measurement arrangements for the determination of luminescence excited in the evanescent field of a planar waveguide, in WO 98/22799 also arrangements with the shape of known microtiter plates are proposed. The determination of multiple analytes upon their binding to different recognition elements immobilized within a single sample compartment, however, is not been taken care of in this disclosure.

In U.S. Pat. Nos. 5,525,466 and 5,738,992, an optical sensor based on fluorescence excitation in the evanescent field of a self-supporting multimode waveguide, preferably of a fiber-optic type waveguide, is described. In-coupling of excitation light and out-coupling of fluorescence light back-coupled into the multimode waveguide are performed via distal-end in-coupling and out-coupling. Based on the operational principle of such multimode waveguides, the fluorescence signal for analyte determination detected thereby is obtained as a single, integral value for the whole surface interacting with the sample. Mainly for the purpose of signal normalization, for example for taking into account signal-altering surface defects, fluorescent reference compounds are co-immobilized on the sensor surface besides the biochemical or biological recognition elements for the specific recognition and binding of an analyte to be determined. Owing to the underlying sensor principle, however, no locally resolved normalization, but only one acting on the single, integral measurement value is possible. Consequently, the determination of different analytes can also only be performed using labels with different excitation wavelengths or sequentially after the removal of analytes that were previously bound. For these reasons, these arrangements—along with the referencing method described—would appear little if at all suitable for the simultaneous determination of numerous analytes.

In WO 97/35181, methods for the simultaneous determination of one or more analytes are described, wherein patches with different recognition elements are deposited in a “well” formed in a waveguide and brought into contact with a sample solution containing one or more analytes. For calibration purposes, solutions with defined analyte concentrations are applied at the same time to further wells with similar patches. As an example, 3 wells each (for measurement of calibration solutions with high and low analyte concentrations as well as the sample solution) with discrete immobilized recognition elements differing from patch to patch are presented for the simultaneous determination of multiple analytes. However, also in this reference there is no evidence to suggest any locally resolved referencing, such as the determination of the excitation light intensity available in the measurement areas.

In Analytical Chemistry Vol. 71 (1999) 4344-4352, a multianalyte immunoassay on a silicon nitride waveguide is presented. Simultaneous determination of up to three analytes on three channel-like recognition regions (measurement areas) with different biological recognition elements is described. The analytes and tracer antibodies are added as a mixture to a sample cell covering the three measurement areas. The background in each case is determined in advance using a solution without analyte specifically prepared for this purpose. It is not clear from the description whether the background determination is performed on a locally resolved basis or integrally for the different measurement areas. Since the sensor platform is not regenerated, many individual measurements have to be performed, using a new sensor platform each time, to generate a calibration curve. This method, resulting from what is only a small number of measurement areas on a sensor platform and from the assay design, has to be seen as a disadvantage, because the precision of the method is reduced when using different sensor platforms and, additionally, the duration of the method is considerably increased.

In Analytical Chemistry Vol. 71 (1999) 3846-3852, a multianalyte immunoassay is also presented for the simultaneous determination of three different analytes. Bacillus globigii, MS2 bacteriophages and staphylococcal enterotoxin B are used as examples of analytes from the groups bacteria, viruses, and proteins, wherein antibodies against these analytes have been immobilized in two parallel rows (channels) on a glass plate acting as a (self-supporting multimode) waveguide. In the course of the multianalyte assay subsequently described, a flow cell with flow channels perpendicular to the rows of immobilized recognition elements is placed on the glass plate. The sandwich immunoassays are performed with the sequential addition of washing solution (buffer), of sample containing one or more analytes, of washing solution (buffer), of tracer antibodies (individually or as a cocktail), and of washing solution (buffer). The locally measured fluorescence intensities are corrected by subtraction of the background signal measured adjacent to the measurement areas. Here, too, there is no evidence to suggest local variations in the excitation light intensity to be taken into account. However, this arrangement, too, does not enable the performance of a whole series of measurements for the simultaneous determination of multiple analytes, together with the necessary calibrations, but requires either the use of several different sensor platforms or repetitive, sequential measurements with intermediate regeneration on a platform, which is possible to only a limited extent especially in the case of immunoassays, additionally being very time-consuming.

In the international application PCT/EP 00/07529 an array of sample compartments is described comprising always two-dimensional arrays of biological, biochemical or synthetic recognition elements for the detection of one or more analytes within an array, the recognition elements being immobilized on an optical waveguide as a carrier. Additionally, one or more measurement areas within each array are provided for referencing. However, this disclosure is silent about the surface density of the immobilized recognition elements, as it is also PCT/EP 00/12668, wherein arrays of flow cells comprising measurement areas provided therein and special reservoirs for receiving exiting liquids are disclosed.

In PCT/EP 01/05995 a kit comprising a sensor platform provided as a thin-film waveguide on which arrays of measurement areas are arranged, is disclosed, the kit comprising means for a laterally resolved referencing of the excitation light intensity available in the measurement areas and, optionally, additional means for a calibration of a generated luminescence signal. However, also this disclosure is silent about the relevance of the immobilization density of the recognition elements for analyte binding.

In contrast, the kit according to the invention provides the following opportunities which are not provided by the arrangements or methods known from the state-of-the-art in a single, common solution:
Simultaneous determination of multiple analytes on a common carrier substrate with detection limits as low as possible. Thus impacts of variations between different carrier substrates on the aanalysis results are avoided.
Performance of these analyses in a plurality of sample compartments on the common carrier substrate, each sample compartment housing arrays of measurement areas with immobilized binding partners for analyte determination in bioaffinity assays. Thus, on the one hand, a large number of different kinds of tests is enabled, which are performed in parallel and/or sequentially on a common carrier substrate, and, on the other hand, the simultaneous determination of a plurality of analytes or test of a plurality of samples under identical conditions is enabled.
Immediate comparability of measurements in different sample compartments on the common carrier substrate, at least one measurement area within each array of measurement areas within a sample compartment being provided for purposes of referencing.
Avoidance of steric hindrance upon binding of the analyte or its binding partner in a bioaffinity assay, the surface density of the immobilized binding partners, in relation to the surface of the measurement areas, being less than the surface density of a full, i.e. extensive, monolayer of said binding partners.

The last-mentioned property of the kit according to the invention, which is principally not considered in the state-of-the-art, is of high importance because of the following reasons: For achieving detection limits as low as possible, it is desired to immobilize as many recognition elements within a space as small as possible in such a way, that in the course of the following detection method as many analyte molecules as possible can be bound. Simultaneously, it is desired to preserve the reactivity and biological or biochemical functionality of the recognition elements to an extent as large as possible upon immobilization, i.e., to minimize any events of denaturation resulting from the immobilization. A density of the immobilized recognition elements in the thus created measurement areas being too large can unintentionally become limiting on the maximum number of analyte molecules that can be bound to the surface, for example because of steric hindrance.

A first subject of the invention is a kit for assay development and for carrying out a plurality of analyses, comprising:
a carrier substrate and
a placement body
   jointly forming an arrangement of a plurality of sample compartments comprising said carrier substrate as a base plate, in addition to
a plurality of immobilized binding partners for the detection of one or more analytes in one or more samples in a bioaffinity assay, said binding partners being arranged and immobilized on the carrier substrate inside the sample compartments always in two-dimensional arrays of discrete measuring areas,
   wherein
always at least one measuring area of an array or a partial surface inside an array or sample compartment, respectively, is provided on the carrier substrate for referencing purposes, and
   the surface density of the immobilized binding partners, in relation to the surface of the measurement areas, is less than the surface density of a full, i.e. extensive, monolayer of said binding partners.

Within the meaning of the present invention, spatially separated or discrete measurement areas (d) shall be defined by the closed area which is occupied by the binding partners immobilized thereon, for the detection of one or more analytes in one or more samples in a bioaffinity assay. Thereby, these areas can have any geometric form, for example the form of circles, rectangles, triangles, ellipses, etc.

The immobilized binding partners may be the one or more analytes themselves, which are deposited on the carrier substrate as the base plate in a native sample matrix or in a modified form of the native sample matrix modified in one or more sample preparation steps. The immobilized binding partners may be, for example, analytes from cell extracts, in particular cell proteins, or antibodies or other proteins serum as a native sample matrix.

Different such measurement areas may comprise, for example, different fractions of a single fractionated sample, or they may comprise a plurality of different samples deposited on the carrier substrate, or different deposited dilutions of one or more samples. In the case of samples separated into fractions the separation may have been performed using any known separation method, such as liquid chromatography (LC), HPLC, thin-layer chromatography, gel chromatography, capillary electrophoresis, etc., or a combination of such separation methods. The material for the discrete measurement areas may also have been provided using selective micro preparation, such as the selective dissection of individual cells from a cellular ensemble by laser capture micro dissection.

More generally, the native sample matrix comprising the analytes to be detected may originate from the group comprising cell extracts, tissue extracts, naturally occurring body fluids, such as blood, serum, plasma, lymph or urine, saliva, tissue fluids, egg yolk and albumen, biological tissue parts, optically turbid liquids, soil or plant extracts as well as bio-process broths and synthetic process broths.

Several different binding partners may be immobilized simultaneously in a measurement area. In the said case that the analytes to be detected are themselves immobilized on the carrier substrate, the detection method is designed in such a way that biological, biochemical or synthetic recognition elements are brought into contact with these analytes. Especially in case of this assay architecture, each measurement area typically comprising several analytes to be determined, for the detection of different analytes, these analytes are brought into contact with corresponding different biological, biochemical or synthetic recognition elements in different measurement areas. For this assay architecture, this is typically performed in different sample compartments. However, the detection of different immobilized analytes can also be performed in such a way that sequentially different recognition elements are supplied to one and the same sample compartment, the complex of an immobilized analyte and the recognition element bound thereto optionally being dissociated upon exposure to so-called chaotropic reagents (for example acidic or basic solutions) after an accomplished step of analyte detection, before the next type of recognition elements, for detection of another analyte, is supplied in a consecutive step of the bioaffinity assay.

Another preferred embodiment of a kit according to the invention comprises the one or more immobilized binding partners being biological, biochemical or synthetic recognition elements for the detection of one or more analytes in one or more samples to be applied.

The immobilized binding partners may be selected from the group formed by proteins, such as monoclonal or polyclonal antibodies and antibody fragments, peptides, enzymes, aptamers, synthetic peptide structures, glyopeptides, oligosaccharides, lectins, antigens for antibodies (e.g. biotin for streptavidin), proteins functionalized with additional binding sites (“tag-proteins” like “histidin-tag-proteins”) and their complex forming partners, as well as nucleic acids (for example DNA; RNA, oligonucleotides) and nucleic acid analogues (e.g. PNA) and their derivatives with synthetic bases.

The immobilized binding partners may also originate from the group formed by soluble, membrane-bound proteins and proteins isolated from a membrane, such as receptors and their ligands.

Furthermore, for example for screening applications in pharmaceutical research and development, compounds of the group formed by acetylenes, alkaloids (for example alkaloids comprising ring structures comprising pyridines, piperidines, tropans, quinolines, iso-quinolines, tropilidenes (1,3,5-cyloheptatrienes), imidazoles, indoles, purines, or phenanthridines), alkaloid glycosides, amines, benzofurans, benzophenones, naphthoquinones (dihydrodikeotnaphthalenes), betains (trimethylglycocolls), carbohydrates (for examples derivatives of sugar, starch and cellulose), carbolines, cardanolides, catechins, chalcones, coumarins, cyclic peptides and polypeptides, depsipeptides, diketopiperazines, diphenyl ethers, flavenes, flavones, iso-flavones, flavonoid alkaloids, furanoquinoline alkaloids, gallocatechols, glucosides, antraquinones, flavonoids, lactones, phenols, hydroquinones, indoles, indoloquinones, alginic acids, lipids (for example oils, waxes and other derivatives of fatty acids), macrolides, oligopeptides, oligostilbenes, peroxides, phenylglycosides, phloroglucines, polyethers, “polyether-antibiotics”, pterocarpines, pyranocoumarines, pyrrols, quassins, quinolines, saframycines, terpenes (mono-, di-, and triterpenes), sesquiterpenes, sesquiterpene dimers, sesquiterpene lactones, sesquiterpene quinines, sesterpenes, staurosporines, steroids (for example steroid hormones, sterols, bile acids), sulfolipids, tannins (for example catachin and pyrogallol), vitamins, ethereal oils and xanthones (for example 9-oxoxantheone) are suited as immobilized binding partners.

It is preferred if the surface density of the immobilized binding partners for the detection of one or more analytes, in relation to the surface of the measurement areas, corresponds to between one tenth and half the surface density of a full monolayer of said binding partners.

Preferably, a controlled surface density of immobilized recognition elements as binding partners is established, the measurement areas containing a mixture, preferably in a controlled mixing ratio, of the biological, biochemical or synthetic recognition elements, for the specific recognition and detection of one or more analytes in an applied sample, with compounds that are “chemically neutral”, i.e. non-binding, towards these analytes or their detection reagents. Thereby, it is also preferred if the surface density of the biological, biochemical or synthetic recognition elements and of the compounds which are “chemically neutral” towards the analytes, immobilized in discrete measurement areas, in relation to the surface of these measurement areas, corresponds, for both types of said components together, to at least two thirds of a full monolayer.

Preferably, the kit according to the invention additionally comprises reagents for purposes of referencing. These reagents may be provided in immobilized form in the measurement areas on the carrier substrate designated for this purpose, or they also may be brought into contact with the measurement areas designated for referencing only in the course of a bioaffinity assay, in order to then generate a desired reference signal.

Preferably, a plurality of sample compartments, as part of a kit according to the invention, is arranged as a two-dimensional array of sample compartments.

There is a variety of possibilities for creating the sample compartments from the carrier substrate and the placement body. The carrier substrate as a base plate and the placement body may be joined in a reversible or irreversible way. The placement body may consist of a single part or also be composed of several parts, the joined parts of the placement then preferably forming an irreversibly joined unit.

For generation of the sample compartments between the carrier substrate as a baseplate and the placement body joined therewith, recesses may be provided in the base plate (carrier substrate) Such recesses may also be provided in said placement body.

Preferably, the recesses between the carrier substrate as a baseplate and the placement body have only a small depth, for example between 1 μm and 1000 μm, in order to keep paths of diffusion towards the surface of the baseplate short. Preferably preferred is a depth between 20 μm and 200 μm. The footprints of the recesses may be uniform or different and have any geometry. For example, they may have rectangular or polygonal shape and a surface area of 0.1 mm² to 200 mm². Typically, the surface area is between 1 mm² and 100 mm² per recess.

Preferably, the carrier substrate as a base plate is essentially planar.

The placement body to be joined with the carrier plate may additionally comprise provisions facilitating the joining with the carrier substrate as the baseplate, such as optical or mechanical markings, stoppers etc.

It is preferred if 2-2000, preferably 2-400, most preferably 2-100 sample compartments are arranged on the common, continuous carrier substrate.

It is especially preferred if the sample compartments are arranged in a pitch, i.e. the geometrical arrangement in rows and/or columns, which is compatible with the pitch of standard microtiter plates. Thereby, an arrangement of 8×12 wells with a (center-to-center) distance of about 9 mm is established as the industrial standard. Smaller arrays with, for example, 3, 6, 12, 24 and 48 wells, arranged at the same distance, are compatible with this standard. Several such smaller arrays of sample compartments may also be combined in such a way that their distance after their combination is an integral multiple of the distance of about 9 mm.

For some time also plates with 384 and 1536 wells, as integral multiples of 96 wells on the same foot print at a correspondingly reduced well-to-well distance (about 4.5 mm and 2.25 mm, respectively), are used, which shall also be called standard microtiter plates. The arrangement of sample compartments as a part of the kit according to the invention may also be adapted to this geometry.

Upon adaptation of the pitch of the sample compartments to these standards a multitude of commercially established and available laboratory pipettors and laboratory robots can be used for sample supply.

A possible embodiment of the sample compartments as a part of the kit according to the invention consists in the sample compartments being open at their side opposite to the carrier substrate as the baseplate.

Characteristic of another possible embodiment is that the sample compartments are closed at the side opposite to the carrier substrate as a base plate, except for inlet and/or outlet openings for the supply or remove of samples and optional additional reagents. It is especially preferred if at least one outlet opening of each sample compartment is connected with an outlet leading into a reservoir being fluidically connected with said sample compartment, said reservoir being operable to receive liquid flowing out of said sample compartment. Thereby, its also preferred if the reservoir for receiving liquids flowing out of the sample compartment is provided as a recess in the external wall of the placement body joined with the base plate. For purposes of compatibility with standard pipettors and laboratory robots, the inlets of the sample compartments are then arranged in a pitch matching the pitch of the standard microtiter plates mentioned above.

If sequentially different sample or reagent liquids are filled into a flow cell, typically a multiple liquid volume compared with the flow cell volume is applied, in order to displace the previously supplied liquid and its contained ingredients as completely as possible. Therefore, its is preferred if the capacity of the reservoirs connected to a sample compartment provided as a flow cell is larger, preferably at least five times larger than the inner volume of the flow cell.

The inner volume of a flow cell may be selected between widely chosen limitations, dependent on the application, for example between 0.1 μl and 1000 μl. Preferably, said inner volume is between 1 μl and 50 μl.

The sample compartments may be closed with an additional covering top, for example a film, a membrane or a cover plate, at their side opposite to the carrier substrate as the base plate.

Preferably, the sample compartments can be temperature-equilibrated.

The materials of the carrier substrate as the base plate, the placement body joined with the base plate and an optional additional cover may be selected from the group comprising plastics that can be formed, molded, embossed or milled, like, for example, polycarbonates, polyimides, acrylates, especially poly methylmethacrylates, polystyrenes, cycloolefin polymers, cycloolefin copolymers, metals, metal oxides, silicates, such as glass, quartz or ceramics and their combinations (mixtures and/or layerings).

Within a sample compartment up to 50,000 measurement areas may be arranged in a two-dimensional arrangement. A single measurement area may have an area of 10⁻⁴ mm²-10 mm². Up to 10,000,000 measurement areas may be provided in a two-dimensional arrangement on the whole carrier substrate. The measurement areas may be arranged at a density of more than 10, preferably of more than 100, most preferably of more than 1,000 measurement areas per square centimeter. The achievable density is determined to a large extent by the method for generating the discrete measurement areas on the carrier substrate. Currently, using mechanical deposition methods, densities up to 10,000 measurement areas per square centimeter can be generated, using photo-lithographic methods up to the order of 1,000,000 measurement areas per square centimeter.

It is characteristic of the kit according to the invention that discrete measurement areas are generated by laterally selective deposition of biological, biochemical or synthetic recognition elements or of samples comprising the one or more analytes in a native sample matrix or in a form of the native sample matrix modified by one or more sample preparation steps on the surface of the carrier substrate or one an adhesion-promoting layer additionally deposited on the carrier substrate, preferably using one or more methods of the group of methods formed by ink jet spotting, mechanical spotting using pen, pin or capillary, micro contact printing, fluidic contacting of the measurement areas with the biological or biochemical or synthetic recognition elements upon their supply in parallel or crossed micro channels, upon application of pressure differences or electric or electromagnetic potentials, and photochemical or photolithographic immobilization methods.

Preferably, regions between the discrete measurement areas are “passivated” for minimization of non-specific binding of analytes, their detection reagents or other binding partners. For this purpose, compounds that are “chemically neutral”, i.e. non-binding, towards the analytes, their detection reagents or other binding partners, are deposited between the laterally separated measurement areas.

Said compounds being “chemically neutral”, i.e. non-binding, towards the analytes, their detection reagents or other binding partners may be selected from the groups formed by albumins, especially bovine serum albumin or human serum albumin, casein, unspecific polyclonal or monoclonal, alien or empirically unspecific antibodies for the one or the multiple analytes to be determined (especially for immuno assays), detergents—such as Tween 20®—fragmented natural or synthetic DNA not hybridizing with polynucleotides to be analyzed, such as extract from herring or salmon sperm (especially for polynucleotide hybridization assays), or also uncharged but hydrophilic polymers, such as poly ethyleneglycols or dextranes.

The simplest method of immobilization of the binding partners for the analyte detection consists in physical adsorption, for example as a result of hydrophobic interaction between the binding partners and the baseplate. However, the extent of these interactions may be substantially altered by the composition of the medium and its physicochemical properties, such as polarity and ionic strength. Especially when different reagents are sequentially added in a multistep assay, the adhesion of the binding partners after only adsorptive immobilization is often insufficient.

Therefore, the binding partners are preferably immobilized on an adhesion-promoting layer deposited on the carrier substrate. It is preferred if the adhesion-promoting layer has a thickness of less than 200 nm, preferably of less than 20 nm. Many materials can be used to produce the adhesion-promoting layer. Without any restriction, it is preferred if the adhesion-promoting layer comprises one or more compounds from the group comprising silanes, functionalized silanes, functionalized, charged or polar polymers and “self-organized passive or functionalized monolayers or multilayers”, alkylphosphates and alkylphosphonates, multifunctional block copolymers, such as poly(L-lysine)/poly(ethylene)glycols.

The adhesion-promoting layer may also comprise compounds of the group of organophosphoric acids with the general formula I(A)
Y—B—OPO₃H₂ (IA)
or of organophosphonic acids with the general formula I(B)
Y—B—PO₃H₂ (IB)
and the salts thereof, wherein B is an alkyl, alkenyl, alkinyl, aryl, aralkyl, hetaryl or hetarylalkyl residue and Y is hydrogen or a functional group from the hydroxy, carboxy, amino, optionally low-alkyl-substituted mono or dialkylamino series, thiol, or a negative acid group from the ester, phosphate, phosphonate, sulfate, sulfonate, maleimide, succinimydyl, epoxy, acrylate series, wherein a biological, biochemical or synthetic recognition element may be coupled to B or Y by addition or substitution reaction, wherein compounds may also be added conferring the substrate surface a resistance to protein adsorption and/or to cell adhesion and in the B chain may optionally be comprised one or more ethylene oxide groups, rather than one or more —CH₂— groups.

In WO 00/65362 coatings of bioanalytical sensor platforms or implants for medical applications using graft copolymers are described, the graft copolymers comprising a polyionic main chain, for example binding (electro-statically) to a carrier, and a “non-interactive” (resistant to adsorption) side chain.

The immobilized binding partners, as parts of a kit according to the invention, may be bound to the free end or close to the free end of a wholly or partly functionalized, “noninteractive” (not charged, resistent to adorption) polymer, wherein said “noninteractive” polymer as a side chain is bound to a charged, polyionic polymer as the main chain and, together with this polymer, forms a polyionic, multifunctional copolymer.

It is characteristic of certain such variants that the polyionic polymer main chain has a cationic (positive) charge at approximately neutral pH. The polyionic main chain may be selected, for example, from the group of polymers comprising amino acids with a positive charge at approximately neutral pH, polysaccharides, polyamines, polymers with quaternary amines, and charged synthetic polymers. The cationic main chain may also comprise molecular groups of the comprising lysine, histidine, arginine, chitosan, partially deacetylated chitin, amine-containing dervatives of neutral polysaccharides, polyamino styrene, polyamine acrylates, polyamine methacrylates, polyethylene imines, poly aminoethylenes, polyamino styrenes, and their N-alkyl derivatives.

Further suited molecular groups, as part of a polyionic main chain, are describes in WO 00/65352, which is incorporated in its full entirety as a part of this disclosure.

Characteristic of another groups of embodiments is that the polyionic main chain has an anionic (negative) charge at approximately neutral pH. Within this group, the cationic main chain may be selected from the group of polymers comprising amino acids with bound groups with a negative charge at approximately neutral pH, polysaccharides and charged synthetic polymers with negatively charged groups.

The cationic polymer main chain may comprise one or more molecular groups from the group comprising poly asparaginic acid, poly glutamic acid, alginic acid or their derivatives, pectin, hyaluronic acid, heparin, heparin sulfate, chondrotitin sulfate, dermatin sulfate, dextrane sulfate, polymethylmethacrylic acid, oxidized cellulose, carboxymethylated cellulose, maleic acid, and fumaric acid.

The “non-interactive” (not charged) polymer as the side chain may be selected from the group comprising poly(alkyleneglycols), poly(alkyleneoxides), neutral water-soluble polysaccharides, polyvinyl alcohols, poly-N-vinylpyrrolidones, phosphorylcholine derivatives, non-cationic poly(meth)acrylates, and their combinations.

It is preferred if the immobilized binding partners are bound to the “non-interactive” side chain at its free end or close to its free end by means of reactive groups. It is especially preferred, if said reactive groups are selected from the group comprising hydroxy (—OH), carboxy (—COOH), ester (—COOR), thiols (—SH), N-hydroxysuccinimide, maleimidyl, quinone, vinyl sulfone, nitrilotriacetic acid, and their combinations.

A variety of further suited polymers and preferred embodiments are addditionaly described in WO 00/65352.

The carrier substrate may comprise multiple layers with different optical properties.

For example, the carrier substrate may comprise a metal oxide layer with refractive index n, on a further layer arranged beneath with a refractive index n₂<n₁. Thereby, it is preferred if the metal oxide being selected from the group comprising TiO₂, Ta₂O₅ or Nb₂O₅.

Characteristic of another variant of a kit according to the invention is that the carrier substrate comprises a thin metal layer, optionally on an intermediate layer arranged beneath, preferably with refractive index <1.5, such as silicon dioxide or magnesium fluoride, wherein the thickness of the metal layer and the optional intermediate layer is selected in such a way that a surface plasmon can be excited at the wavelength of the irradiated excitation light and/or at the wavelength of a generated luminescence. Thereby, its is preferred if the metal being selected from the group comprising gold and silver. Preferably, the thickness of the metal layer is between 10 nm and 1000 nm, most preferably between 30 nm and 200 nm.

Characteristic of another preferred variant of a kit according to the invention is that the carrier substrate is transparent at least at the wavelength of an irradiated excitation light or measurement light.

Thereby, an irradiated “excitation light” shall mean that this light is used as an energy source for a secondary emission (in summary called “emission light”), such as fluorescence, luminescence or a Raman radiation or, for example, for excitation of a surface plasmon in a metal layer, which secondary emission is measured with a suitable detector. An irradiated “measurement light” shall mean that this light is also used for an interaction between the carrier substrate and/or analytes to be detected thereon or their binding partners for purposes of analyte detection, but no spectral changes of this measurement light or a secondary emission are to be investigated rather than, for example, changes of the adjustment parameters (such as the resonance angle for the in-coupling into a grating waveguide structure, see below) or the propagation parameters of this light (such as the phase difference between light fractions propagating along different optical paths, like the measurement path and the reference path, without interaction with a sample, of an interferometer) are measured.

It is advantageous if the carrier substrate, as a part of a kit according to the invention, is provided as a continuous optical waveguide or comprises discrete waveguiding areas. It is especially preferred if the carrier substrate is provided as an optical film waveguide with a first optically transparent layer (a) facing the recesses of the sample compartments on a second optically transparent layer (b) with lower refractive index than layer (a). It is known, for example from the patent applications WO 95/33197, WO 95/33198 and WO 96/35940, that especially low detection limits for an analyte detection can be achieved using sensor platforms based on thin-film waveguides combined with detection of fluorescence excited in the evanescent field of a light guided in the waveguide.

Thereby, the second optically transparent layer (b) may comprise a material from the group that is formed by silicates, e.g. glass or quartz, transparent thermoplastic or moldable plastics, for example polycarbonates, polyimides, acrylates, especially polymethylmethacrylates, or polystyrenes.

It is preferred if the refractive index of the first optically transparent layer is greater than 1.8. It is also preferred if the first optically transparent layer (a) comprises a material of the group of TiO₂, ZnO, Nb₂O₅, Ta₂O₅, HfO₂, or ZrO₂, especially preferred of TiO₂ or Nb₂O₅ or Ta₂O₅.

For a given material of the layer (a) and a given refractive index the sensitivity is the better, the smaller the layer thickness is, as long as the layer thickness is larger than a lower limiting value. The lower limiting value is determined by the cease of light-guiding upon decrease of the layer thickness below a value that is dependent on the wavelength of the light to be guided and by an increase of the propagation losses with decreasing layer thickness in case of very thin layers. It is preferred if the product of the thickness of layer (a) and its refractive index is one tenth up to a whole, preferably one third to two thirds of the excitation wavelength of an excitation light to be coupled into layer (a).

If an autofluorescence of layer (b) cannot be excluded, especially if it comprises a plastic such as polycarbonate, or for reducing the effect of the surface roughness of layer (b) on the light guiding in layer (a), it can be advantageous, if an intermediate layer is deposited between layers (a) and (b). Therefore, another embodiment of the carrier substrate as a part of the kit according to the invention, comprises an additional optically transparent layer (b′) with lower refractive index than layer (a) and in contact with layer (a), and with a thickness of 5 nm-10 000 nm, preferably of 10 nm-1000 nm, being provided between the optically transparent layers (a) and (b).

A variety of methods are known for the in-coupling of excitation light or measurement light into an optical waveguide. In case of a relatively thick waveguiding layer, up to a self-supporting waveguide, it is possible to focus the light into a butt face of the waveguide, using lenses of adequate numerical aperture, in such a way that the light is guided by total internal reflection. In case of waveguides with larger width of the butt face than waveguide thickness, cylindrical lenses are preferably used for this purpose. Thereby, the lenses may be arranged spatially separated from the waveguides as well as directly connected to the waveguides. In case of lower thicknesses of the waveguiding layer, this type of butt-coupling is less suited. Then, coupling by means of prisms, which are preferably joined with the waveguide upon avoiding any gaps or applying an index-matching liquid between the prism and the waveguide, is better suited. It is also possible to supply the excitation light to the waveguide by means of an optical fiber or to couple the waveguide to the light in-coupled into another waveguide by arranging both waveguides in such a close distance that their evanescent fields overlap and an energy transfer can occur. Therefore such embodiments are a part of the invention, the kit according to the invention comprising one or more optical coupling elements for the in-coupling of excitation light or measurement light towards the measurement areas on the carrier substrate provided as an optical waveguide. Thereby, said optical coupling elements may be selected from the group comprising prism couplers, evanescent couplers with joined optical waveguides featuring overlapping evanescent fields, butt-face couplers with focusing lenses, preferably cylindrical lenses, arranged in front of an end face of the waveguiding layer, optical fibers as light guides, and coupling gratings, wherein said coupling elements may be joined with the carrier substrate or arranged remote from it.

Preferably, the carrier substrate comprises one or more grating structures (c) as coupling gratings for the in-coupling of excitation light or measurement light towards the measurement areas, which grating structures are modulated as diffractive gratings in the optically transparent layer (a). The gratings may be relief gratings featuring any profile, for example rectangular, triangular, saw tooth, semi-circular, or sinusoidal profile, or phase or volume gratings with a periodic modulation of the refractive index in the essentially planar layer (a). Preferably, grating structures (c) are provided as surface relief gratings.

Therefore, it is characteristic of a further variant of the kit according to the invention that the carrier substrate comprises one or more grating structures (c) or a second group of one or more grating structures (c′) as out-coupling gratings for the out-coupling of light guided in layer (a). Preferably, also these grating structures are modulated as surface relief gratings in the optically transparent layer (a). Thereby, grating structures (c) and (c′) may have the same or different period and may be oriented in parallel or not in parallel with respect to each other. Grating structures (c) and (c′) may interchangeably be used as in-coupling and/or out-coupling gratings.

The grating structures (c) and/or (c′) may be mono-diffractive or multi-diffractive and have a depth of 2 nm-100 nm, preferably of 10 nm-30 nm, and a period of 200 nm-1000 nm, preferably of 300 nm-700 nm. The ratio between the width of the grating ribs and the grating period may be between 0.01 and 0.99, a ratio between 0.2 and 0.8 being preferred.

It is characteristic of one group of embodiments of a kit according to the invention that the detection of one or more analytes upon binding of binding partners provided in solution to the binding partners immobilized in discrete measurement areas for analyte detection based on resulting changes in the effective refractive index in the region of said measurement areas is enabled. As mentioned above, the immobilized binding partners may be the analytes to be detected themselves, for example embedded in a native sample matrix, the binding partners being brought into contact with biological, biochemical or synthetic recognition elements in the course of a detection method, or the immobilized binding partners may be immobilized recognition elements being brought into contact with a sample containing the analytes.

Thereby, the two-dimensional areas of measurement areas are preferably always arranged on a common grating structure (c).

For the embodiments of the inventive kit based on a detection of changes in the effective refractive index, again several variants are possible for solving the task of referencing.

One variant comprises one or more measurement areas comprising deposited compounds that are “chemically neutral” towards the analytes or their detection reagents being provided in each area for referencing.

Such type of referencing is especially well suited if a grating waveguide structure as described in PCT/EP 01/00605 is used as a carrier substrate of a kit according to the invention for laterally resolved detection of changes in the effective refractive index, said disclosure being incorporated at its full entirety in this disclosure.

Imaging methods for detection of changes in the effective refractive index resulting from changes in mass coverage on a grating waveguide structure or on a metal layer of an arrangement for generation of a surface plasmon resonance may be realized by irradiating an expanded, parallel bundle of excitation light or measurement light, in a large-area illumination manner, onto the surface to be tested, optionally comprising discrete measurement areas (preferably in a two-dimensional array) generated on said surface at or approximately at the resonance conditions for in-coupling of light into the waveguiding layer or for excitation of the surface plasmon resonance, respectively. These resonance conditions to be satisfied may be the corresponding resonance angle, upon variation of the irradiation angle at a constant irradiated wavelength, or the resonance wavelength, upon variation of the irradiation wavelength at a constant irradiation angle. Based on local variations of the degree of fulfillment of the corresponding resonance conditions, for example resulting in corresponding local differences in the light fractions to be measured in a transmission or reflection configuration, local differences in the mass coverage may be detected using a laterally resolving detector.

In case of an imaging grating waveguide structure or arrangement for excitation of surface plasmon resonance, a controlled different mass coverage of the surface, to be monitored by corresponding differences in the effective refractive index, may be achieved by means of the compounds immobilized in discrete measurement areas and being “chemically neutral” towards the analytes, their detection reagents or other binding partners. Thus it is possible to scale changes in the effective refractive index, in case of the binding of analytes or any of their detection reagents or binding partners in the measurement areas dedicated for analyte detection according to the known value of a signal change at a controlled different mass coverage and to calculate accordingly the unknown change in surface mass coverage for analyte detection.

In a corresponding manner, one or more measurement areas comprising deposited compounds as mass labels (e.g. molecular complexes, in particular between the recognition labels and the analytes to be detected, or particles or beads) of known amount and known molecular weight being provided in each array for calibration and/or referencing.

It is also possible that one or more partial areas within an array or a sample compartment, respectively, on the carrier substrate, which have been “passivated” by deposition of compound which are “chemically neutral” towards the analytes or their detection reagents, are provided for referencing.

Characteristic of another large group of embodiments of a kit according to the invention, that said kit enables the detection of one or more analytes upon binding of binding partners provided in solution to the binding partners immobilized in discrete measurement areas for analyte detection based on resulting changes in a luminescence signal, for example of molecules capable for luminescence and bound to the analyte or one of its binding partners or to detection reagents for the analytes, in the region of said measurement areas.

A possible variant for this group of embodiments is that molecules capable of luminescence which do not bind to the analytes or their detection reagents are immobilized as luminescence labels in always one or more measurement areas of an array for referencing the excitation light intensity available in the region of the corresponding array. In case of a carrier substrate provided as an optical waveguide with a waveguiding optically transparent layer (a) the intensity of the light available in the region of the array corresponds to the intensity of the light there guided in the waveguiding layer located beneath.

Thereby, it is preferred if said luminescence labels (used for purposes of referencing) are bound to the immobilized binding partners or to a known percentage of the immobilized binding partners.

A further possibility comprises not measurement areas especially dedicated for referencing purposes being provided, but molecules capable of luminescence being deposited as luminescence labels for purposes of referencing in the same measurement areas wherein also the binding partners for analyte detection. Thereby, the referencing may serve for the determination of different parameters assuming that the luminescence labels applied for purposes of referencing are provided at a known amount or at a known mixing ratio with the other molecules immobilized in a measurement area. On the one hand, in such a way the excitation light intensity available in the measurement area may again be determined. On the other hand, the immobilization density may be determined from the luminescence signal of these labels, in case of a known local excitation light intensity and the known mixing ratio with the immobilized binding partners. This means in summary that molecules capable of luminescence are deposited as luminescence labels for referencing the excitation light intensity available in the region of the corresponding array (or the excitation light intensity guided in the waveguiding layer (a) of a carrier substrate provided as an optical waveguide, respectively) or for referencing the surface density of the immobilized binding partners in said measurement areas, said luminescence labels being immobilized in the same measurement areas as the immobilized binding partners.

It is also possible that said luminescence labels (used for purposes of referencing) are bound to the immobilized binding partners or to a known percentage of the immobilized binding partners.

Said luminescence labels (used for purposes of referencing) may also be provided in a mixture, at a known mixing ratio, with the immobilized binding partners in the measurement areas dedicated for this purpose.

It is preferred if luminescent dyes or nanoparticles which can be excited and/or emit at a wavelength between 300 nm and 1100 nm are used as luminescence labels (used for referencing purposes).

It is of advantage if an inventive kit, according to any of the mentioned embodiments, additionally comprises reagents for performing assays.

These additional reagents for performing an assay may be selected, for example, from the group comprising assay buffers, hybridization buffers, washing solutions and solutions of luminescently labeled “tracer probes” (e.g. antibodies in immunoassays or single-stranded nucleic acids in nucleic acid hybridization assays) and solutions causing dissociation of bio-complexes (e.g. so-called “chaotropic reagents with a high content of salts/high ionic strength and/or of markedly acidic nature for dissociation of antigen-antibody complexes or urea solutions for dissociation of hybridized nucleic acid strands).

Said additional reagents for performing an assay may be supplied from externally to the sample compartments.

Another variant comprises said additional reagents being integrated in compartments of the placement body and supplied to the sample compartments during an assay, if adequate after a wetting step.

A further subject of the invention is an analytical system for assay development and for carrying out a plurality of analyses on a common, continuous carrier substrate, comprising
a kit according to any of the embodiments mentioned above,
a receiving device for insertion of the body formed by the carrier substrate and the placement body, comprising the binding partners immobilized in two-dimensional arrays of measurement areas in the sample compartments and optionally additional reagents,
at least one detector for detection of light emanating from the regions of the arrays and, in particular, from the measurement areas.

It is preferred if the at least one detector is a locally resolving detector, which is preferably selected from the group comprising CCD cameras, CCD chips, photodiode arrays, Avalanche diode arrays, multichannel plates, and multichannel photomultipliers.

Preferably, the analytical system comprises at least one excitation light source for emission of excitation light or measurement light to be delivered to the arrays and their measurement areas. Thereby, said light source is preferably a spectrally narrow-band or even monochromatic light source, such as a laser. The analytical system according to the invention may also comprise special optical components fort irradiation of an essentially monochromatic excitation light or measurement light towards the measurement areas.

For a variety of embodiments of the analytical system according to the invention, it is necessary to adjust precisely the angle of the light irradiated towards the carrier substrate and the region of incidence of the light on the carrier substrate. Therefor it is preferred if the analytical system additionally comprises one or more adjustment components for adjusting the angle of incidence of an excitation light or measurement light incident on the carrier substrate.

In the optical path between the one or more excitation light sources and the carrier substrate and/or between said carrier substrate and the one or more detectors, optical components of the group comprising lenses or lens systems for the shaping of the transmitted light bundles, planar or curved mirrors for the deviation and optionally additional shaping of the light bundles, prisms for the deviation and optionally spectral separation of the light bundles, dichroic mirrors for the spectrally selective deviation of parts of the light bundles, neutral density filters for the regulation of the transmitted light intensity, optical filters or monochromators for the spectrally selective transmission of parts of the light bundles, or polarization selective elements for the selection of discrete polarization directions of the excitation or measurement light and/or optionally a luminescence light may be provided.

Often it is necessary to perform measurements at a constant and often also well-defined, predefined temperature. For example, data related to reaction or bindings kinetics are principally always referred to a certain temperature, and the sensitivity of measurements of refractivity (for example based on the resonance angle for in-coupling of light into a waveguiding layer or for excitation of a surface plasmon) may be limited by temperature variations, because of the dependence of the refractive index on temperature.

The irradiation of the excitation or measurement light towards the measurement areas may be performed in a configuration of epi-illumination or transmission illumination. Characteristic of a possible configuration is that the irradiation of the excitation or measurement light towards the measurement areas and the detection of light emanating from the measurement areas are performed at opposite sides of the carrier substrate.

It is preferred if the irradiation of the excitation or measurement light towards the measurement areas and the detection of light emanating from the measurement areas are performed at the same side of the carrier substrate, preferably at the outside of the carrier substrate which is opposite to its side facing the sample compartments. This is associated with the advantage that a passage of the excitation or measurement light through the sample liquid (in case of a supplied liquid sample), before interaction with the analyte molecules bound to the surface of the carrier substrate or their detection reagents, can be avoided. Based on this configuration, a passage of excitation light or measurement light through the sample solution may be avoided even completely (except for the penetration depth of the evanescent field) in case of an interaction within the evanescent field of a wave guide in a waveguiding layer of the carrier substrate or of a surface plasmon in a metal film provided on the carrier substrate.

A further possibility comprises the irradiation of the excitation light or the measurement light and the collection of the light emanating from the measurement areas being performed in a confocal configuration.

The excitation light or measurement light my be irradiated continuously or also in a pulsated way. Therefore, the analytical system according to the invention may comprise components enabling the irradiation of excitation or measurement light at pulses with a duration between 1 fsec and 10 minutes. Characteristic of a preferred embodiment of the analytical system according to the invention is that it comprises components enabling a time-resolved collection of the light emanating from the measurement areas.

It is preferred if the analytical system comprises optical components enabling the irradiation of an essentially parallel excitation light or measurement light bundle towards the measurement areas. It is of particular advantage if the analytical system comprises optical components for beam expansion, generating an essentially parallel ray bundle being irradiated for large-area illumination towards the measurement areas.

Characteristic of a special group of embodiments of the analytical system according to the invention is that said analytical system enables a detection of changes in the resonance conditions for excitation of a surface plasmon in a metal layer being part of the carrier substrate. The change in the resonance conditions to be monitored may consist in a change in the resonance angle of the irradiated excitation light with respect to the surface normal of the carrier substrate for excitation of a surface plasmon in the metal layer, at constant irradiated excitation wavelength. For this purpose, for example, an almost parallel excitation light bundle is irradiated, and a minimum in reflection or transmission occurs when matching the resonance condition.

The excitation light may also be irradiated at a constant angle, and the excitation wavelength may be varied close to fulfillment of the resonance condition (for example using a spectrally tunable laser). Then, accordingly, the change in the resonance conditions to be monitored consists in the change in the resonance wavelength of an excitation light irradiated at a constant angle for excitation of a surface plasmon in the metal layer.

Thereby, such an embodiment of the analytical system is preferred which enables a locally resolved detection of changes in the resonance conditions for excitation of a surface plasmon in the metal layer.

Characteristic of another group of preferred embodiments of an analytical system according to the invention is being operable to enable a detection of changes in the resonance conditions for in-coupling an excitation light or measurement light into the waveguiding layer (a) by means of a grating structure (c) or for out-coupling of light guided in layer (a) by means of a grating structure (c) or (c′).

The change in the resonance conditions may again consist in the change in a resonance angle, in this case for the in-coupling or out-coupling of an excitation light or measurement light or of a light guided in the waveguiding layer (a), the light being essentially monochromatic with a constant wavelength. The change in the resonance conditions may also consist in the change in the resonance wavelength for in-coupling of an excitation light or measurement light into the waveguiding layer (a) irradiated at a constant angle.

Again, such embodiments of a corresponding analytical system according to the invention are preferred which enable a locally resolved detection of changes in the resonance conditions for in-coupling an excitation light or measurement light into the waveguiding layer (a) by means of a grating structure (c) or for out-coupling of light guided in layer (a) by means of a grating structure (c) or (c′). Optical systems suited as parts of analytical systems according to the invention are disclosed, for example, in PCT/EP 01/00605, which is incorporated into this application in its full entirety.

Characteristic of another group of preferred embodiments is being operable to enable a locally resolved detection and measurement of luminescence light emanating from the region of the arrays, in particular from the measurement areas. Thereby, it is characteristic of a specially preferred embodiment that the analytical system comprises components effecting irradiation of the excitation light at the resonance angle for in-coupling into the waveguiding layer (a) by means of a grating structure (c) modulated in said layer, as part of the carrier substrate, such that the in-coupled excitation light is guided in the layer (a) and luminescence labels are excited to luminescence within the penetration depth of the evanescent field in the region of the sample compartments, and emanated luminescence is collected using a collection optics and directed to one or more detectors, and the detector signal is stored by a storage medium.

A further subject of the invention is a method for assay development and for carrying out a plurality of analyses, the samples to be analyzed for one or more analytes being brought into contact, either immediately or after mixture and incubation with further reagents and, if necessary, further sample preparation steps, with biological, biochemical or synthetic recognition elements in one or more sample compartments being part of a kit, comprising:
a carrier substrate and
a placement body
   jointly forming an arrangement of a plurality of sample compartments comprising said carrier substrate as a base plate, in addition to
a plurality of immobilized binding partners for the detection of one or more analytes in one or more samples in a bioaffinity assay, said binding partners being arranged and immobilized on the carrier substrate inside the sample compartments always in two-dimensional arrays of discrete measuring areas,
   wherein
always at least one measuring area of an array or a partial surface inside an array or sample compartment, respectively, is provided on the carrier substrate for referencing purposes, and
the surface density of the immobilized binding partners, in relation to the surface of the measuring areas, is less than the surface density of a full, i.e. extensive, monolayer of said binding partners,
   further reagents are supplied to the sample compartments, if necessary,
   the carrier substrate joined with the placement body thus forming sample compartments comprising the samples and, optionally, additionally supplied reagents is inserted into a receiving device of an analytical system according to any of the embodiments mentioned above,
   the light emanating from the regions of the arrays and, in particular, from the measurement areas in the sample compartments is measured with at least one detector, and
   the detector signals are recorded by a storage medium.

It is preferred if said plurality of sample compartments is arranged as a two-dimensional array of sample compartments.

The immobilized binding partners may be the one or more analytes themselves, which are deposited on the carrier substrate as the base plate in a native sample matrix or in a modified form of the native sample matrix modified in one or more sample preparation steps.

Thereby, the native sample matrix comprising the analytes to be detected may originate from the group comprising cell extracts, tissue extracts, naturally occurring body fluids, such as blood, serum, plasma, lymph or urine, saliva, tissue fluids, egg yolk and albumen, biological tissue parts, optically turbid liquids, soil or plant extracts as well as bio-process broths and synthetic process broths.

It is characteristic of these embodiments of the method that biological, biochemical or synthetic recognition elements for the detection of the one or more immobilized analytes are brought into contact with said immobilized analytes in one or more measurement areas in a bioaffinity assay.

Thereby it is preferred if, for the detection of different analytes in different measurement areas these analytes are brought into contact with different biological, biochemical or synthetic recognition elements. For the detection of different analytes, this is preferably performed in different sample compartments. However, the detection of different immobilized analytes may also be performed in such a way that different recognition elements are supplied sequentially to one and the same sample compartment, the complex formed between an immobilized analyte and a bound recognition element being dissociated upon exposure to so-called chaotropic reagents (such as acidic or basic solutions) following an accomplished analyte detection step, if necessary, before the next type of recognition elements, for the detection of another analyte, is supplied in a consecutive step of the bioaffinity assay.

Characteristic of another preferred group of embodiments of the method according to the invention is the one or more immobilized binding partners being biological, biochemical or synthetic recognition elements for the detection of one or more analytes in one or more samples to be applied.

For assuring a controlled surface density of the immobilized recognition elements corresponding to less than a monolayer, it is preferred if the measurement areas comprise a mixture, preferably at a controlled mixing ratio, of the biological, biochemical or synthetic recognition elements, for the specific recognition and binding of one or more analytes in a supplied sample, with compounds that are “chemically neutra”, i.e. non-binding towards these analytes or their detection reagents or further binding partners.

For this variant, it is further preferred if the surface density of the biological, biochemical or synthetic recognition elements and of the compounds which are “chemically neutral” towards the analytes, immobilized in discrete measurement areas, in relation to the surface of these measurement areas, corresponds, for both types of said components together, to at least two thirds of a full monolayer.

Then, the method according to the invention is typically designed in such a way that the immobilized biological, biochemical or synthetic recognition elements being brought into contact with one or more samples containing the one or more samples and, if necessary, with further reagents either sequentially or in a single application step, after mixture of the one or more samples with the optional additional reagents, in the sample compartments.

It is also preferred if a plurality of analytes is determined within an array after application of a single sample.

In the method according to the invention, it is advantageous if the sample compartments are closed at the side opposite to the carrier substrate as a base plate, except for inlet and/or outlet openings for the supply or remove of samples and optional additional reagents, and the samples are filled locally addressed, either immediately or after mixture and incubation with further reagents, if necessary, and optionally after further sample preparation steps, and optionally further reagents into the sample compartments. It is also preferred if at least one outlet opening of each sample compartment is connected with an outlet leading into a reservoir being fluidically connected with said sample compartment, the samples are filled locally addressed, either immediately or after mixture and incubation with further reagents, if necessary, and optionally after further sample preparation steps, and optionally further reagents into the sample compartments, and liquid exiting the sample compartments is received by said reservoirs.

Thereby, it is advantageous if the capacity of a reservoir fluidically connected to a sample compartment is larger, preferably at least five times larger than the inner volume of said sample compartment.

Especially when performing the method at elevated temperature, for example in hybridization assays, it is also preferred if the sample compartments are closed with an additional covering top, for example a film, a membrane or a cover plate, at their side opposite to the carrier substrate as the base plate after the filling. It is also advantageous if the sample compartments are temeperature-equilibrated.

It is characteristic of the method according to the invention that discrete measurement areas are generated on the surface of the carrier substrate or on an additional adhesion-promoting layer deposited on the carrier substrate by locally selective deposition of biological, biochemical or synthetic recognition elements or of samples comprising the one or more analytes in a native sample matrix or in modified form of the native sample matrix, which has been modified in one or more steps, preferably using one or more methods of the group of methods comprising ink jet spotting, mechanical spotting using pen, pin or capillary, micro contact printing, fluidic contacting of the measurement areas with the biological or biochemical or synthetic recognition elements upon their supply in parallel or crossed micro channels, upon application of pressure differences or electric or electromagnetic potentials, and photochemical or photolithographic immobilization methods.

The method is characterized that up to 50,000 measurement areas may be arranged in a two-dimensional arrangement. A single measurement area may have an area of 10⁻⁴ mm²-10 mm². Up to 10,000,000 measurement areas may be provided in a two-dimensional arrangement on the whole carrier substrate. The measurement areas may be arranged at a density of more than 10, preferably of more than 100, most preferably of more than 1,000 measurement areas per square centimeter.

It is preferred if regions between the discrete measurement areas are “passivated” for minimization of non-specific binding of analytes or their detection reagents, i.e. that compounds that are “chemically neutral” towards the analytes, their detection reagents or other binding partners, are deposited between the laterally separated measurement areas.

It is also advantageous if an adhesion-promoting layer is deposited on the carrier substrate before immobilization of the binding partners. Preferably, this adhesion-promoting layer has a thickness of less than 200 nm, most preferably of less than 20 nm.

Selection suited for said “chemically neutral” compounds have been mentioned above already, as well as the choice of compounds suitable for an adhesion-promoting layer and the variety of adequate binding partners to be immobilized.

The excitation or measurement light may be irradiated towards the measurement areas in a configuration of epi-illumination or transmission illumination.

The method may be designed in such a way that irradiation of the excitation or measurement light and collection of the light emanating from the measurement areas are performed at opposite sides of the carrier substrate.

For many applications, however, it is advantageous if the irradiation of the excitation or measurement light towards the measurement areas and the detection of light emanating from the measurement areas being performed at the same side of the carrier substrate, preferably at the outside of the carrier substrate which is opposite to its side facing the sample compartments.

It is preferred if almost monochromatic excitation or measurement light is generated by means of suitable optical components, such as monochromatically emitting light sources (e.g. lasers) or spectrally selective optical components (e.g. interference filters or monochromators) and irradiated towards the measurement areas.

It is also advantageous if an almost parallel excitation or measurement light bundle being generated by means of suitable optical components and irradiated towards the measurement areas.

It is preferred in particular if an essentially parallel ray bundle is generated by means of suitable optical components for beam expansion and irradiated towards the measurement areas in a manner of large-area illumination.

It is characteristic of special group of embodiments of the method according to the invention that the detection of the one or more analytes to be detected is based on a change in the resonance conditions for generating a surface plasmon in a thin metal layer as part of the carrier substrate, resulting from the binding of the one or more analytes to a biological, biochemical or synthetic recognition element or to one or more further binding partners on a bioaffinity assay, on the surface of said carrier substrate or on an adhesion-promoting layer deposited on the carrier substrate. The change in the resonance conditions may consist in a change in the resonance angle between an irradiated, essentially monochromatic excitation light bundle and the surface normal of the carrier substrate, for excitation of a surface plasmon in the metal layer. Alternatively, the change in the resonance conditions may consist in a change in the resonance wavelength of an essentially parallel excitation light bundle irradiated at a constant angle, for excitation of a surface plasmon in the metal layer.

Characteristic of a preferred variant of this group of embodiments of the method according to the invention is that a laterally resolved determination of changes in the resonance conditions for generating surface plasmons in the metal layer of a carrier substrate is performed by irradiation of an expanded, parallel excitation light bundle towards the measurement areas on the carrier substrate in a manner of large-area illumination and/or by scanning the carrier substrate with respect to the excitation light bundle.

For another, preferred group of embodiments of the method according to the invention, it is characteristic that the carrier substrate is provided as a continuous optical waveguide or comprising discrete waveguiding areas.

Thereby, it is preferred if the carrier substrate is provided as an optical film waveguide with a first optically transparent layer (a) facing the recesses of the sample compartments on a second optically transparent layer (b) with lower refractive index than layer (a).

Materials suitable for the optically transparent layers (a) and (b) and their desired properties have already been described above.

It is often advantageous if an additional optically transparent layer (b′) with lower refractive index than layer (a) and in contact with layer (a), and with a thickness of 5 nm-10 000 nm, preferably of 10 nm-1000 nm, is provided between the optically transparent layers (a) and (b).

It is preferred if the excitation or measurement light from one or more light sources is in-coupled into the waveguiding layer by means of one or more optical coupling elements and guided towards the measurement areas on the carrier substrate provided as an optical waveguide, wherein said optical coupling elements may be selected from the group comprising prism couplers, evanescent couplers with joined optical waveguides featuring overlapping evanescent fields, butt-face couplers with focusing lenses, preferably cylindrical lenses, arranged in front of an end face of the waveguiding layer, optical fibers as light guides, and coupling gratings, wherein said coupling elements may be joined with the carrier substrate or arranged remote from it.

It is especially preferred if the excitation or measurement light from one or more light sources is coupled into layer (a) by means of one or more grating structures (c) as coupling gratings, which are modulated as surface relief gratings in the optically transparent layer (a), and the in-coupled light being guided towards the measurement areas.

A possible variant of the method comprises light guided in layer (a) of the carrier substrate being out-coupled by means of one or more grating structures (c) or a second group of one or more grating structures (c′) as out-coupling gratings, which are modulated as surface relief gratings in the optically transparent layer (a), wherein grating structures (c) and (c′) have the same or different period and are oriented in parallel or not in parallel with respect to each other.

It is characteristic of a preferred group of embodiments of the method according to the invention that the detection of the one or more analytes to be detected is based on a change in the effective refractive index in the region of the measurement areas formed by the immobilized binding partners and arranged in two-dimensional arrays, resulting from the binding of the one or more analytes to biological, biochemical or synthetic recognition elements or to one or more further binding partners on a bioaffinity assay, on the surface of said carrier substrate or on an adhesion-promoting layer deposited on the carrier substrate.

Thereby, it is preferred if the two-dimensional arrays of measurement areas are always arranged on a common grating structure (c).

A possible variant within this group of embodiments of the method according to the invention comprises one or more measurement areas comprising deposited compounds that are “chemically neutral” towards the analytes or their detection reagents or binding partners being provided in each area for referencing.

Another possibility is that one or more measurement areas comprising deposited compounds as mass labels (e.g. molecular complexes, in particular between the recognition labels and the analytes to be detected, or particles or beads) of known amount and known molecular weight are provided in each array for calibration and/or referencing. It is also possible that one or more partial areas within an array or a sample compartment, respectively, on the carrier substrate, which have been “passivated” by deposition of compound which are “chemically neutral” towards the analytes or their detection reagents, are provided for referencing.

These possibilities of referencing, as part of the method according to the invention, have been explained in more detail already above.

Characteristic of another preferred group of embodiments of the method according to the invention is that the detection of the one or more analytes is based on the change in a luminescence signal, for example from molecules capable for luminescence and bound to the analyte or one of its binding partners or to detection reagents for the analyte as luminescence label, resulting from the binding of the one or more analytes to a biological, biochemical or synthetic recognition element or to one or more further binding partners on a bioaffinity assay, on the surface of said carrier substrate or on an adhesion-promoting layer deposited on the carrier substrate.

One possibility comprises molecules capable of luminescence or lminescent nanoparticles which do not bind to the analytes or their detection reagents being immobilized as luminescence labels in always one or more measurement areas of an array for referencing the excitation light intensity available in the region of the corresponding array.

Thereby, it is preferred if said luminescence labels (used for purposes of referencing) emit at a wavelength that is different from the emission wavelength of such molecules capable of luminescence or luminescence labels, which are applied for analyte detection.

Another possibility comprises molecules capable of luminescence being deposited as luminescence labels for referencing the excitation light intensity available in the region of the corresponding array or for referencing the surface density of the immobilized biological, biochemical or synthetic recognition elements in said measurement areas, said luminescence labels being immobilized in the same measurement areas as the immobilized recognition elements.

It is preferred if said luminescence labels (used for purposes of referencing) are bound to the immobilized biological, biochemical or synthetic recognition elements or to a known percentage of these immobilized recognition elements.

Another possible variant comprises said luminescence labels (used for purposes of referencing) being provided in a mixture, with a known mixing ratio, with the immobilized biological, biochemical or synthetic recognition elements in the measurement areas dedicated for this purpose.

It is also preferred if the luminescent dyes or luminescent nanoparticles used as luminescence labels for purposes of referencing can be excited and emit at a wavelength between 300 nm and 1100 nm.

As an advancement of the method according to the invention, the applied inventive kit additionally comprises reagents for performing assays. These additional reagents for performing an assay may be selected from the group comprising assay buffers, hybridization buffers, washing solutions and solutions of luminescently labeled “tracer probes” (e.g. antibodies in immunoassays or single-stranded nucleic acids in nucleic acid hybridization assays) and solutions causing dissociation of bio-complexes (e.g. so-called “chaotropic reagents with a high content of salts/high ionic strength and/or of markedly acidic nature for dissociation of antigen-antibody complexes or urea solutions for dissociation of hybridized nucleic acid strands).

Thereby, said additional reagents for performing an assay may be supplied from externally to the sample compartments. Another possible variant comprises said additional reagents being integrated in compartments of the placement body and supplied to the sample compartments during an assay, if adequate after a wetting step.

Characteristic of a specially preferred embodiment of the method according to the invention is that said carrier substrate is provided as an optical film waveguide comprising a first optically transparent layer (a) on a second optically transparent layer (b) which has a lower refractive index than layer (a), excitation light is coupled into the optically transparent layer (a), by means one or more grating structures (c) provided in the optically transparent layer (a), and guided as a guided wave towards measurement areas arranged above layer (a), the luminescence from molecules capable of luminescence generated in the evanescent field of said guided wave is detected by one or more detectors, and the relative concentration or amount of one or more analytes is determined from the intensity of these luminescence signals.

It is possible to measure (1) the isotropically emitted luminescence or (2) luminescence that is in-coupled into the optically transparent layer (a) and out-coupled via grating structures (c) or luminescences of both parts (1) and (2) at the same time.

Preferably, also for the generation of luminescence for purposes of analyte detection, a luminescent dye or luminescent nanoparticles is used as luminescence labels, which may be excited and emits at a wavelength between 300 nm and 1100 nm.

Furthermore, it is preferred if luminescence labels for purposes of analyte detection is bound to the analyte or, in a competitive assay, to an analogue of the analyte or, in a multistep assay, to one of the binding partners of the immobilized biological, biochemical or synthetic recognition elements or to the biological, biochemical or synthetic recognition elements.

A modification of the method comprises the use of a second luminescence label or of further luminescence labels with excitation wavelengths either the same as or different from that of the first luminescence label and the same or different emission wavelength.

Thereby, one possible variant is that the second luminescence label or further luminescence labels can be excited at the same wavelength as the first luminescence dye, but emit at different wavelengths.

For certain applications, however it is advantageous if the excitation spectra and emission spectra of the luminescence dyes used overlap only a little, if at all.

Characteristic of a special variant of the method is that charge or optical energy transfer from a first luminescence dye serving as donor to a second luminescence dye serving as acceptor is used for analyte detection.

Characteristic of a further possible variant of the method according to the invention is that changes in the effective refractive index on the measurement areas are determined in addition to determining one or more luminescences.

For improving sensitivity, it may be advantageous if the one or more luminescences and/or determinations of light signals at the excitation wavelength are measured polarization-selective. It is preferred that the one or more luminescences are measured at a polarization that is different from the one of the excitation light.

The method according to the invention and any of the described embodiments is claimed for the simultaneous and/or sequential, quantitative and/or qualitative detection of one or more analytes of the group formed by proteins, such as monoclonal or polyclonal antibodies and antibody fragments, peptides, enzymes, aptamers, synthetic peptide structures, glyopeptides, oligosaccharides, lectins, antigens for antibodies (e.g. biotin for streptavidin), proteins functionalized with additional binding sites (“tag-proteins” like “histidin-tag-proteins”) and their complex forming partners, as well as nucleic acids (for example DNA; RNA, oligonucleotides) and nucleic acid analogues (e.g. PNA) and their derivatives with synthetic bases, and soluble, membrane-bound proteins and proteins isolated from a membrane, such as receptors and their ligands.

The method is also suited for the simultaneous and/or sequential, quantitative and/or qualitative detection of one or more analytes of the group formed by acetylenes, alkaloids (for example alkaloids comprising ring structures comprising pyridines, piperidines, tropans, quinolines, iso-quinolines, tropilidenes (1,3,5-cyloheptatrienes), imidazoles, indoles, purines, or phenanthridines), alkaloid glycosides, amines, benzofurans, benzophenones, naphthoquinones (dihydrodikeotnaphthalenes), betains (trimethyl-glycocolls), carbohydrates (for examples derivatives of sugar, starch and cellulose), carbolines, cardanolides, catechins, chalcones, coumarins, cyclic peptides and polypeptides, depsipeptides, diketopiperazines, diphenyl ethers, flavenes, flavones, iso-flavones, flavonoid alkaloids, furanoquinoline alkaloids, gallocatechols, glucosides, antraquinones, flavonoids, lactones, phenols, hydroquinones, indoles, indoloquinones, alginic acids, lipids (for example oils, waxes and other derivatives of fatty acids), macrolides, oligopeptides, oligostilbenes, peroxides, phenylglycosides, phloroglucines, polyethers, “polyether-antibiotics”, pterocarpines, pyranocoumarines, pyrrols, quassins, quinolines, saframycines, terpenes (mono-, di-, and triterpenes), sesquiterpenes, sesquiterpene dimers, sesquiterpene lactones, sesquiterpene quinines, sesterpenes, staurosporines, steroids (for example steroid hormones, sterols, bile acids), sulfolipids, tannins (for example catachin and pyrogallol), vitamins, ethereal oils and xanthones (for example 9-oxoxantheone).

It is characteristic of the method according to the invention that the samples to be tested are naturally occurring body fluids such as blood, serum, plasma, lymph or urine or tissue fluids, or egg yolk or optically turbid fluids or surface water or dissolved soil or plant extracts or biological or synthetic process broths, or are taken from biological tissue parts.

A further subject of the invention is the use of a kit and/or of an analytical system and/or of an analytical method, each according to any of the described embodiments, for quantitative or qualitative analyses for the determination of chemical, biochemical or biological analytes in screening methods in pharmaceutical research, combinatorial chemistry, clinical and pre-clinical development, for real-time binding studies and for the determination of kinetic parameters in affinity screening and in research, for qualitative and quantitative analyte determinations, especially for DNA- and RNA analytics and the determination of genomic or proteomic differences in the genome. Such as single-nucleotide polymorphisms, for the measurement of protein-DNA interactions, for the determination of control mechanisms for mRNA-expression and for the protein (bio)synthesis, for generation of toxicity studies and for the determination of expression profiles, especially for the determination of biological and chemical marker compounds, such as mRNA, proteins and low-molecular organic (messenger) compounds, and for the determination of antibodies, antigens, pathogens or bacteria in pharmaceutical product research and development, human and veterinary diagnostics, agrochemical product research and development, for symptomatic and pre-symptomatic plant diagnostics, for patient stratification in pharmaceutical product development and for the therapeutic drug selection, for the determination of pathogens, nocuous agents and germs, especially of salmonella, prions, virus, and bacteria, especially in food and environmental analytics.

The invention will be further explained by means of the following examples.

### SHORT DESCRIPTION OF THE FIGURES

FIG. 1 shows a linear arrangement of 5 arrays of measurement areas on a baseplate, comprising grating structures (c) for the in-coupling of excitation light towards the measurement areas. The direction of propagation of the light in the region of the arrays is indicated with an arrow.

FIG. 2 shows average values of fluorescence signals, after correction for background and referencing, measured in a method for the detection of human interleukin 4 (hIL-4), for different concentrations of the solutions deposited on the baseplate for immobilization of anti-hIL-4 antibodies as specific binding partners.

FIG. 3 shows the slope of the regression lines of FIG. 2 as a function of the concentration of the anti-hIL-4 antibodies in the immobilization solution.

FIG. 4 shows the geometrical arrangement of an array of “reference spots” (comprising Cy5-BSA) and “recognition element spots”, generated from a 75% solution of serum comprising different concentrations of interferon gamma.

FIG. 5 shows average values of fluorescence signals, after correction for background and referencing, measured in a method for the detection of human interferon gamma, measured for different concentrations of human interferon gamma in the immobilization solution containing 75% serum using the array of FIG. 4.

### EXAMPLES

### Example 1

### Kit for the Simultaneous Quantitative Detection of the Human Cytokine IL-4 Using Different, Well-Defined Surface Densities of the Anti-IL-4 Antibodies Immobilized as Binding Partners in Discrete Measurement Areas; Analytical System Based on an Inventive Kit and Detection Method Performed Therewith

a) Kit According to the Invention

A planar optical thin-film waveguide with the dimensions 16 mm width×48 mm length×0.7 mm thickness, comprising a glass substrate (AF 45) and 150 nm thin, highly refractive layer of tantalum pentoxide deposited thereon, is used as a carrier substrate being part of a kit according to the invention. Surface relief gratings (grating period: 320 nm, grating depth (12+/−2) nm) are modulated at a distance of 9 mm in the carrier substrate, in parallel to the width. Upon deposition of the highly refractive layer these structures, to be used as diffractive gratings for the in-coupling of light into the highly refractive layer, had been transferred into the surface of the tantalum pentoxide layer.

After careful cleaning, a monolayer of mono-dodecyl phosphate (DDP) as an adhesion-promoting layer is generated by spontaneous self-assembly on the surface of the metal oxide layer, upon deposition from an aqueous solution (0.5 mM DDP). This surface modification of the previously hydrophilic metal oxide surface leads to a hydrophobic surface (with a contact angle of about 100° against water), as a preparation for the immobilization of the binding partners for analyte detection.

5 identical arrays of 77 measurement areas (spots) each, in an arrangement of 11 rows and 7 columns for each array, are deposited on the planar optical waveguide as the baseplate provided with the hydrophobic adhesion-promoting layer, using an inkjet plotter, model NPIC (GeSiM, Grosserkmannsorf, Germany). Each spot was generated by deposition of a single drop with a volume of 400 μl on the baseplate.

A commercial mono-clonal mouse antibody (MAB604, R&D Systems, Abingdon, UK) is used as a recognition element and dissolved at different concentration of 5, 10, 20, 50 and 100 μg/ml in phosphate-buffered saline solution, for generating different surface densities upon immobilization.

Besides the measurement areas comprising immobilized recognition elements (“recognition element spots”) for interleukin 4, each array contains further measurement areas comprising immobilized bovine serum albumin fluorescently labelled with Cy5 (Cy5-BSA), which are used for referencing local and/or temporal variations of the excitation light intensity (“reference spots”) during the measurement. Cy5-BSA (labelling rate: 3 Cy5 molecules per BSA molecule) is deposited at a concentration of 300 pM in phosphate-buffered saline solution (PBS, pH 7.4).

After deposition of the recognition element spots and the reference spots, the void hydrophobic surface regions of the baseplate not coated with protein are saturated with bovine serum albumin (BSA), upon incubating the surface with a solution of BSA (30 mg/ml) in a saline solution buffered with imidazole (10 mM). Then the baseplate comprising the measurement areas generated thereon is washed with water and then dried in a stream of nitrogen.

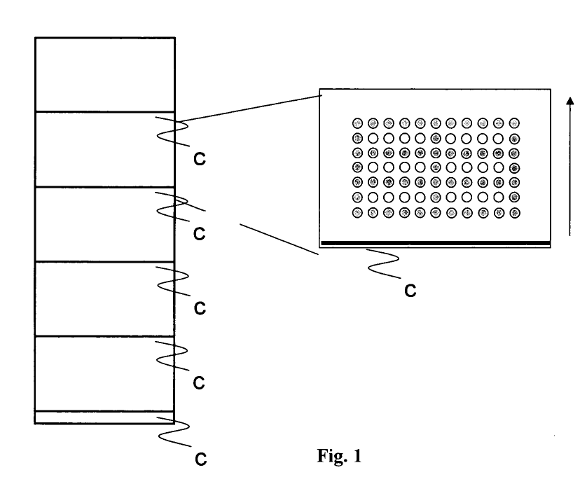

The geometry of the arrangement of the spots within an array and a linear arrangement of five arrays on one baseplate are shown in FIG. 1. The diameter of the spots, arranged at a (center-to-center) distance of 500 μm, is about 120 μm. Each individual array comprises five different surface densities of the recognition elements deposited in discrete spots, corresponding to the deposition from the antibody solutions of different concentrations, and additionally measurement areas comprising pure deposited buffer solution, without dissolved anti-IL-4 antibodies, as a control for non-specific binding. The recognition element spots are arranged in six rows each comprising four replicates of the same concentration. During the detection process to be performed later on, the rows with the always four replicates are orientated perpendicular to the direction of propagation of the light to be guided in the highly refractive waveguiding layer, in order to obtain data about the statistical assay reproducibility already from each individual measurement per sample to be supplied. The reference spots (grey spots in FIG. 1) are arranged in parallel to the rows of antibody spots in such a way that always one recognition element spot is located adjacent to at least two reference spots in the direction of propagation of the excitation light. The reference spots are used for referencing the excitation light that is available in the adjacent measurement areas for analyte detection.

In the course of the later performed detection method, the excitation light is always in-coupled into the highly refractive layer by means of a grating structure (c), being then guided in the highly refractive layer along the direction of the arrow according to FIG. 1.

The baseplate thus prepared is then joined with a placement body of black polycarbonate, in a linear arrangement comprising five recesses opened towards the baseplate, each recess comprising one inlet opening and one outlet opening directed towards the opposite side of the placement body, in such a way that together with the baseplate a linear arrangement of five sample compartments is generated, each provided as flow-through cells. Thereby, the dimensions of the recesses are selected in such a way that within each sample compartment, close to a limiting wall, a coupling grating (c) is located which is followed (in the direction of propagation of the guided light, i.e. along the direction of the arrow in FIG. 1) by an array of measurements. The sample compartments have a capacity of 50 μl each.

b) Analytical System with a Kit According to the Invention

A kit according to the invention, comprising the baseplate according to Example 1.a) with the arrays of measurement areas generated thereon and the placement body joined with said baseplate, together forming a linear arrangement of sample compartments, is mounted on an adjustment unit allowing for translation in parallel and perpendicular to the grating lines and rotation around an axis in parallel to the grating lines of the baseplate. A shutter allowing for blocking the light path, when no measurement data are to be collected, is provided in the light path immediately after the laser used as an excitation light source. Neutral density filters or polarizers may be placed at this position or also other positions in the further path of the excitation light towards the planar optical waveguide as the baseplate, in order to vary the excitation light intensity stepwise or continuously.

The excitation light beam of a helium neon laser (Melles-Friot 05-LHP-901, 1.1 mW) is expanded in one dimension by means of cylindrical lens and directed though a slit-type aperture (0.5 mm×7 mm aperture) for generating a light ray bundle of approximately rectangular cross-section and almost homogeneous cross-sectional intensity. Thereby, the polarization of the laser light is oriented in parallel to the grating lines of the sensor platform, for excitation of the TE₀-mode at in-coupling conditions. The excitation light is directed through the back side of the sensor platform, i.e. through the optically transparent substrate layer of lower refractive index, towards the in-coupling grating within one of the five sample compartments. The angle between the sensor platform and the irradiated excitation light bundle is adjusted to maximum in-coupling into the highly refractive waveguiding layer upon rotation around the axis described above. Under the described conditions, the resonance angle for in-coupling in air is about −10° (with respect to the surface normal of the baseplate).

A CCD camera (Ultra Pix 0401E, Astrocam, Cambridge, UK) with Peltier cooling (operation temperature: −30° C.) and a Kodak CCD chip KAF 0401 E-1 is used as a laterally resolving detector. Signal collection and focusing onto the CCD chip is performed using a Computar tandem objective (f=50 mm, 1:1.3). Thereby, light emitted towards and passing through the transaparent substrate layer is collected. 2 interference filters (Omega, Brattleborough, Vt.) with a central wavelength of 680 nm and 40 nm bandwidth and either a neutral density filter (for transmission of the attenuated, scattered excitation light and the much weaker luminescence light from the measurement areas) or a neutral density filter in combination with an interference filter (for transmission of attenuated excitation light scattered at the measurement areas) are mounted on a filter changer between the two halves of the tandem objective. The signals at the excitation wavelength and the luminescence wavelength may be measured in turns. Data analysis is performed using either commercially available image analysis software (ImagePro Plus) or a self-written image analysis software (ZeptoView).

c) Method for Assay Development/Analytical Detection Method Using a Kit According to the Invention

For the specific recognition of the analyte IL-4 to be detected the format of a sandwich assay is chosen.

Sample Preparation:

5 calibration solutions of the interleukin 4 (hIL-4) to be determined quantitatively, of 100 μl each in a saline solution (NaCl 100 mM, pH 7.4) buffered with imidazole (50 mM) containing 0.1% BSA and 0.05% Tween 20, are prepared, the calibration solutions containing 0, 10, 50, 250, and 500 pg/ml hIL-4, respectively. These calibration solutions are dedicated for the generation of calibration curves upon application on the corresponding dedicated arrays on the sensor chip.

The calibration solutions are then each mixed with 100 μl of a solution containing the secondary, poly-clonal tracer antibody: 100 pM biotinylated anti-hIL-4 antibody (BAF204, R&D Systems, Abingdon, UK) in saline solution (NaCl 100 mM, pH 7.4) buffered with imidazole (50 mM), containing 0.1% BSA and 0.05% Tween 20). These mixtures of 200 μl volume each are then each mixed with 200 μl of a solution of Cy5-streptavidin (2×10⁻⁹ M, Amersham Biosciences, Dübendorf, Switzerland) in saline solution (NaCl 100 mM, pH 7.4) buffered with imidazole (50 mM), containing 0.1% BSA and 0.05% Tween 20.

Then the produced calibration solutions are incubated for one hour in the dark at ambient temperature, before the incubates (100 μl each) are filled into the sample compartments of the inventive kit. Thereby, the calibration solutions are filled into always one of the five linearly arranged the sample compartments at increasing concentration. After a further incubation at 37° C. in the dark for two hours, the binding signals from the arrays of measurement areas are measured using an analytical system according to the invention.

Read-Out of the Arrays:

For the read-out of the fluorescence signals from the measurement areas of the arrays, the inventive kit according to Example 1.a), comprising comprising the baseplate with the arrays of measurement areas generated thereon and the placement body joined with said baseplate, together forming a linear arrangement of sample compartments, is mounted on computer-controlled adjustment unit within the analytical system described above. For determination of the fluorescence signals from each array, the baseplate is adjusted for maximum in-coupling of the excitation light by means of the grating structure dedicated for the array to be measured, which adjustment is controlled in a feedback method upon positioning the filter exchanger for the excitation wavelength, measuring the light out-coupled at the consecutive grating, in direction of propagation of the guided excitation light, with a photodiode, and maximizing the resultant photodiode signal upon further adjustment of the positioning unit. The read-out of the arrays in the further sample compartments is performed sequentially, upon translation of the kit one array position to the next one.

Data Analysis and Referencing:

The image analysis is performed using a self-written image analysis software (ZeptoView). Thereby, the integrated fluorescence intensity is determined for each measurement area (“spot”) for each array, from which an average background value is subtracted which is determined from the surrounding regions without immobilized recognition elements. Thus, always four integrated background-corrected values of fluorescence intensities per array are obtained for the six different recognition element densities, from are then calculated, for statistical purposes, the average values and the standard deviations.

Additionally, for each recognition element spot the two reference spots located adjacent to it, with respect to the direction of propagation (i.e. before and behind) are analyzed in a similar way, and their average signal intensity is determined. The reference values such averaged are used for the correction (upon division by the averaged reference value) of the corresponding luminescence signals from the measurement areas for analyte detection (recognition element spots) located in the same row, assuming a constant signal intensity at constantly kept external conditions (proportional to the excitation light intensity).

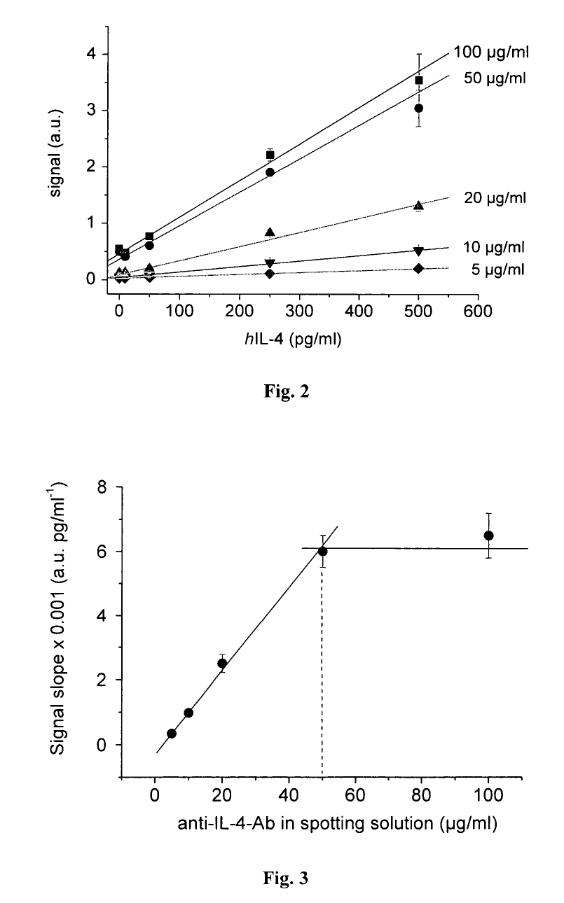

FIG. 2 shows the concentration-dependent signal standard curves of this immunoassay, generated for interleukin 4. The integral values of fluorescence intensities at different surface densities of the binding partner immobilized for analyte detection (mono-clonal mouse antibody MAB604, corresponding to its concentration in the solutions used for immobilization), each value averaged from 4 spots, are plotted as function of the hIL-4 concentration. The straight lines correspond to linear fits (regression lines) of these corrected data.

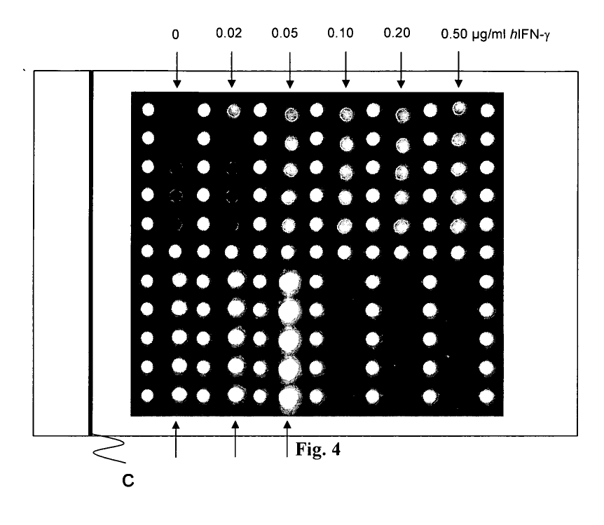

For each of the 5 measurement curves, the slope of the corresponding regression line was determined. In FIG. 3, these slopes are plotted as a function of the concentration of the anti-hIL-4 antibody in the different spotting solutions used for its immobilization. In the concentration range between 0 μg/ml and 50 μg/ml, the slopes increase linearly. The concentration of 50 μg/ml appears like a threshold concentration where a maximum of the slope is approximated. The further increase in concentration of the immobilization solution (spotting solution) to 100 μg/ml does not lead to a further significant increase in the slope of the corresponding measurement curve. It is concluded that the surface density of primary antibodies MAB604 available for binding cannot be further increased by an increase in the concentration of the spotting solution beyond 50 μg/ml.

Estimation of the Surface Density of the Immobilized Binding Partners

At a threshold concentration of 50 μg/ml, the number of primary antibodies (MAB604, molecuklar weight about 150,000 D) having been deposited within the area of a single spot with a droplet of 400 μl volume corresponds to about 10⁸ antibody molecules. Assuming at this threshold concentration a complete surface coverage of a measurement area (spot) with antibodies, for a spot diameter of about 120 μm, a value of 100 nm²-120 nm² is determined as the space required by a single primary antibody immobilized on the surface, corresponding to a diameter of 10-11 nm. This floor space required does well correlate with statements in current text books about the size of antibodies and also with corresponding experimental data from atomic force microscopy, where a comparable value for the floor space required by an antibody on a mica or glass surface was determined (Fritz, J., Anselmetti, D., Jarchow, J., and Fernandez-Busquets, X., J. Struct. Biol. 1997, 119, 165-171). Based on this good correlation, it may be assumed that really a complete coverage of the spot area with primary antibodies (i.e. an extensive monolayer) is provided for the plateau region of FIG. 3 under the described experimental conditions (at a concentration of the immobilization solution of more than 50 μg/ml). As a conclusion, all analyte signals from the described experiment for concentrations of the spotting solutions of less than 50 μg/ml are measured at conditions of sub-monolayer coverage with primary antibodies in the spots.

### Example 2

### Kit Comprising the Analytes Themselves being Deposited as Immobilized Binding Partners in their Native Sample Matrix (Serum) on the Baseplate of said Kit, and Detection Method Performed Therewith

a) Kit According to the Invention

An optical thin-film waveguide as described in Example 1.a) is used as carrier substrate, on which again a monolayer of mono-dodecyl phosphate (DDP) is deposited by self-assembly as an adhesion-promoting layer.

Human interferon gamma (hIFN-γ) is used as the analyte, which shall be deposited, dissolved in calf serum as an example of a native sample matrix, on the baseplate of the kit. For this purpose, solutions comprising 75% calf serum (Newborn.Calf Serum, Anawa, Zürich, Switzerland) are prepared in 10% phosphate-buffered saline solutions (PBS, pH 7.4), to which human interferon gamma (hIFN-γ) is added as specific analyte at concentrations of 0, 0.02, 0.05, 0.10, 0.20, 0.50, 1.0, 2.0, amd 5.0 μg/ml.

5 identical arrays of 143 measurement areas (spots) each, in an arrangement of 11 rows and 13 columns for each array, are deposited on the planar optical waveguide as the baseplate provided with the hydrophobic adhesion-promoting layer, using an inkjet plotter, model NPIC (GeSiM, Grosserkmannsorf, Germany).

Besides the measurement areas comprising the analyte itself immobilized in an, in this example, only slightly modified form of a native sample matrix, each array contains further measurement areas comprising immobilized bovine serum albumin fluorescently labelled with Cy5 (Cy5-BSA). Cy5-BSA (labelling rate: 3 Cy5 molecules per BSA molecule) is deposited at a concentration of 6 nM in 10% phosphate-buffered saline solution (PBS, pH 7.4), additionally comprising 200 μg/ml non-labeled BSA.

After deposition of the recognition element spots and the reference spots, the void hydrophobic surface regions of the baseplate not coated with protein are saturated with bovine serum albumin (BSA), upon incubating the surface with a solution of BSA (30 mg/ml) in a saline solution (10 mM, pH 7.4) buffered with imidazole (10 mM). Then the baseplate comprising the measurement areas generated thereon is washed with water and then dried in a stream of nitrogen.

The diameter of the spots, arranged at a (center-to-center) distance of 500 μm, is about 120 μm. Each individual array comprises recognition element spots with nine different surface densities of the immobilized binding partners, which have been generated upon addition of hIFN-γ at the concentrations specified above to the spotting solutions.

The recognition element spots are arranged in nine rows each comprising five replicates for the same concentration of added hIFN-γ. During the detection process to be performed later on, the rows with the always five replicates are orientated perpendicular to the direction of propagation of the light to be guided in the highly refractive waveguiding layer, in order to obtain data about the statistical assay reproducibility already from each individual measurement per sample to be supplied. The reference spots (continuous row of bright spots in FIG. 4) are arranged in such a way that always one recognition element spot is located adjacent to at least two reference spots in the direction of propagation of the excitation light. The reference spots are used for referencing the excitation light that is available in the adjacent measurement areas for analyte detection.

The baseplate prepared as described above is joined in a similar manner as decribed in Example 1.a) with a placement body of black polycarbonate, in order to generate again a linear array of sample compartments comprising the arrays of measurement areas.

For the measurement, the same analytical system and read-out method as described in Example 1.b) is used. The individual arrays are excited using red laser light (633 nm). The exposure time for image acquisition is 3 seconds.

b) Analytical Detection Method Using a Kit According to the Invention

For the specific recognition of the hIFN-γ to be detected, the assay format of the direct detection of the binding of a fluorescently labelled ant-hIFN-γ antibody to the analyte molecules immobilized in the measurement areas is chosen. For this purpose, a detection solution of a saline solution (NaCl, 100 mM, pH 7.4, with 0.1% BSA and 0.05% Tween 20) buffered with imidazole (50 mM) is prepared, comprising a polyclonal biotinylated antibody against hIFN-γ (3 nM 285-IF-100, R&D Systems, Abingdon, UK) and 5 nM Cy5-streptavidin (Amersham Biosciences, Dübendorf, Switzerland). The required Cy5-labeled detection antibody against hIFN-γ is obtained upon binding the fluorescently labelled streptavidin to the biotinylated antibody.

The detection solution is filled into the sample compartments of the inventive kit. After teo hours of incubation in the dark at 37° C., the arrays are measured with the inventive analytical system according to Example 1.b).

Data Analysis and Referencing:

The image analysis is performed using a self-written image analysis software (ZeptoView). Thereby, the integrated fluorescence intensity is determined for each measurement area (“spot”) for each array, from which an average background value is subtracted which is determined from the surrounding regions without immobilized recognition elements. Thus, always five integrated background-corrected values of fluorescence intensities per array are obtained for the nine different recognition element densities in the measurement areas for analyte detection, from which are then calculated, for statistical purposes, the average values and the standard deviations.

Additionally, for each recognition element spot the two reference spots located adjacent to it, with respect to the direction of propagation (i.e. before and behind) are analyzed in a similar way, and their average signal intensity is determined. The reference values such averaged are used for the correction (upon division by the averaged reference value) of the corresponding luminescence signals from the measurement areas for analyte detection (recognition element spots) located in the same row, assuming a constant signal intensity at constantly kept external conditions (proportional to the excitation light intensity).

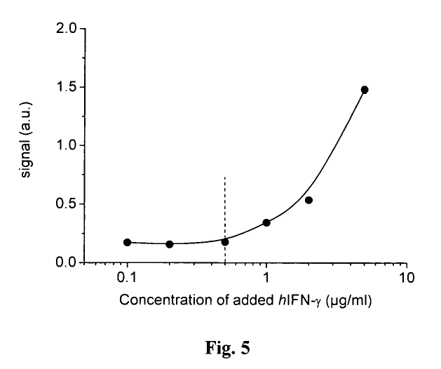

FIG. 5 shows the averaged fluorescence intensities, plotted as function of the hIFN-γ concentration in the spotting solution. The error bars represent the standard deviations from 5 replicates.

Determination of the Minimum Detectable Ratio of Analyte to the Total Protein Concentration a Native Sample Matrix

The total protein concentration of the used serum is determined by a commonly used standard method (according to Bradford) and is 15 mg/ml. Consequently, in case of the dilution of the immobilization solution to 75% content of serum performed in this example, the total protein content is 11.3 mg/ml. The minimum detectable amount of analyte in this sample matrix is determined from FIG. 5. The detection limit is determined from that fluorescence signals which corresponds to the sum of the background signal and its two-fold standard deviation. Accordingly, the minimum detectable analyte concentration is 0.5 μg/ml. Consequently, in this case the minimum mass ratio of analyte and the total protein concentration in the sample matrix is 1:22,600. By comparison with the results of Example 1.c) it is concluded, that in this second example the surface density of the binding partners immobilized in the measurement areas is only a small fraction of a monolayer.

1-105. (canceled)

106. A kit for assay development and for carrying out a plurality of analyses, comprising:
a carrier substrate and
a placement body
jointly forming an arrangement of a plurality of sample compartments comprising said carrier substrate as a base plate, in addition to
a plurality of immobilized binding partners for the detection of one or more analytes in one or more samples in a bioaffinity assay, said binding partners being arranged and immobilized on the carrier substrate inside the sample compartments always in two-dimensional arrays of discrete measuring areas,
wherein
always at least one measuring area of an array or a partial surface inside an array or sample compartment, respectively, is provided on the carrier substrate for referencing purposes, and
the surface density of the immobilized binding partners, in relation to the surface of the measurement areas, is less than the surface density of a full, i.e. extensive, monolayer of said binding partners.

107. A kit according to claim 106, additionally comprising reagents for purposes of referencing.

108. A kit according to claim 106, said plurality of sample compartments being arranged as a two-dimensional array of sample compartments.

109. A kit according to claim 106, the one or more immobilized binding partners being the one or more analytes themselves, which are deposited on the carrier substrate as the base plate in a native sample matrix or in a modified form of the native sample matrix modified in one or more sample preparation steps.

110. A kit according to claim 106, the native sample matrix comprising the analytes to be detected originating from the group comprising cell extracts, tissue extracts, naturally occurring body fluids, such as blood, serum, plasma, lymph or urine, saliva, tissue fluids, egg yolk and albumen, biological tissue parts, optically turbid liquids, soil or plant extracts as well as bio-process broths and synthetic process broths.

111. A kit according to claim 109, biological, biochemical or synthetic recognition elements for the detection of the one or more immobilized analytes being brought into contact with said immobilized analytes in one or more measurement areas in a bioaffinity assay.

112. A kit according to claim 106, the one or more immobilized binding partners being biological, biochemical or synthetic recognition elements for the detection of one or more analytes in one or more samples to be applied.

113. A kit according to claim 106, said immobilized binding partners being selected from the group formed by proteins, such as monoclonal or polyclonal antibodies and antibody fragments, peptides, enzymes, aptamers, synthetic peptide structures, glyopeptides, oligosaccharides, lectins, antigens for antibodies (e.g. biotin for streptavidin), proteins functionalized with additional binding sites (“tag-proteins” like “histidin-tag-proteins”) and their complex forming partners, soluble, membrane-bound proteins and proteins isolated from a membrane, such as receptors and their ligands as well as nucleic acids (for example DNA; RNA, oligonucleotides) and nucleic acid analogues (e.g. PNA) and their derivatives with synthetic bases.

114. A kit according to claim 106, said immobilized binding partners being selected from the group formed by acetylenes, alkaloids (for example alkaloids comprising ring structures comprising pyridines, piperidines, tropans, quinolines, iso-quinolines, tropilidenes (1,3,5-cyloheptatrienes), imidazoles, indoles, purines, or phenanthridines), alkaloid glycosides, amines, benzofurans, benzophenones, naphthoquinones (dihydrodikeotnaphthalenes), betains (trimethyl-glycocolls), carbohydrates (for examples derivatives of sugar, starch and cellulose), carbolines, cardanolides, catechins, chalcones, coumarins, cyclic peptides and polypeptides, depsipeptides, diketopiperazines, diphenyl ethers, flavenes, flavones, iso-flavones, flavonoid alkaloids, furanoquinoline alkaloids, gallocatechols, glucosides, antraquinones, flavonoids, lactones, phenols, hydroquinones, indoles, indoloquinones, alginic acids, lipids (for example oils, waxes and other derivatives of fatty acids), macrolides, oligopeptides, oligostilbenes, peroxides, phenylglycosides, phloroglucines, polyethers, “polyether-antibiotics”, pterocarpines, pyranocoumarines, pyrrols, quassins, quinolines, saframycines, terpenes (mono-, di-, and triterpenes), sesquiterpenes, sesquiterpene dimers, sesquiterpene lactones, sesquiterpene quinines, sesterpenes, staurosporines, steroids (for example steroid hormones, sterols, bile acids), sulfolipids, tannins (for example catachin and pyrogallol), vitamins, ethereal oils and xanthones (for example 9-oxoxantheone).

115. A kit according to claim 106, wherein the immobilized binding partners are bound to the free end or close to the free end of a wholly or partly functionalized, “noninteractive” polymer.

116. A kit according to claim 106, the carrier substrate being transparent at least at the wavelength of an irradiated excitation light or measurement light, and said kit being operable to enable the detection of one or more analytes upon binding of binding partners provided in solution to the binding partners immobilized in discrete measurement areas for analyte detection based on resulting changes in a luminescence signal, for example of molecules capable for luminescence and bound to the analyte or one of its binding partners or to detection reagents for the analytes, in the region of said measurement areas.

117. A kit according to claim 116, wherein molecules capable of luminescence which do not bind to the analytes or their detection reagents are immobilized as luminescence labels in always one or more measurement areas of an array for referencing the excitation light intensity available in the region of the corresponding array (or the excitation light intensity guided in the waveguiding layer (a) of a carrier substrate provided as an optical waveguide, respectively).

118. A kit according to claim 116, wherein molecules capable of luminescence being deposited as luminescence labels for referencing the excitation light intensity available in the region of the corresponding array (or the excitation light intensity guided in the waveguiding layer (a) of a carrier substrate provided as an optical waveguide, respectively) or for referencing the surface density of the immobilized binding partners in said measurement areas, said luminescence labels being immobilized in the same measurement areas as the immobilized binding partners; and
wherein said luminescence labels (used for purposes of referencing) being bound to the immobilized binding partners or to a known percentage of the immobilized binding partners or being provided in a mixture, at a known mixing ratio, with the immobilized binding partners in the measurement areas dedicated for this purpose.

119. A kit according to claim 106, additionally comprising reagents for performing an assay.

120. A kit according to claim 119, said additional reagents for performing an assay being selected from the group comprising assay buffers, hybridization buffers, washing solutions and solutions of luminescently labeled “tracer probes” (e.g. antibodies in immunoassays or single-stranded nucleic acids in nucleic acid hybridization assays) and solutions causing dissociation of bio-complexes (e.g. so-called “chaotropic reagents with a high content of salts/high ionic strength and/or of markedly acidic nature for dissociation of antigen-antibody complexes or urea solutions for dissociation of hybridized nucleic acid strands).

121. An analytical system for assay development and for carrying out a plurality of analyses on a common, continuous carrier substrate, comprising
a kit according to claim 106,
a receiving device for insertion of the body formed by the carrier substrate and the placement body, comprising the binding partners immobilized in two-dimensional arrays of measurement areas in the sample compartments and optionally additional reagents,
at least one detector for detection of light emanating from the regions of the arrays and, in particular, from the measurement areas.

122. A method for assay development and for carrying out a plurality of analyses, the samples to be analyzed for one or more analytes being brought into contact, either immediately or after mixture and incubation with further reagents and, if necessary, further sample preparation steps, with biological, biochemical or synthetic recognition elements in one or more sample compartments being part of a kit, comprising:
a carrier substrate and
a placement body
jointly forming an arrangement of a plurality of sample compartments comprising said carrier substrate as a base plate, in addition to
a plurality of immobilized binding partners for the detection of one or more analytes in one or more samples in a bioaffinity assay, said binding partners being arranged and immobilized on the carrier substrate inside the sample compartments always in two-dimensional arrays of discrete measuring areas,
wherein
always at least one measuring area of an array or a partial surface inside an array or sample compartment, respectively, is provided on the carrier substrate for referencing purposes, and
the surface density of the immobilized binding partners, in relation to the surface of the measuring areas, is less than the surface density of a full, i.e. extensive, monolayer of said binding partners,
further reagents are supplied to the sample compartments, if necessary,
the carrier substrate joined with the placement body thus forming sample compartments comprising the samples and, optionally, additionally supplied reagents is inserted into a receiving device of an analytical system according to claim 121,
the light emanating from the regions of the arrays and, in particular, from the measurement areas in the sample compartments is measured with at least one detector, and
the detector signals are recorded by a storage medium.

123. A method according to claim 122, the immobilized binding partners being the one or more analytes themselves, which are deposited on the carrier substrate as the base plate in a native sample matrix or in a modified form of the native sample matrix modified in one or more sample preparation steps.

124. A method according to claim 123, the native sample matrix comprising the analytes to be detected originating from the group comprising cell extracts, tissue extracts, naturally occurring body fluids, such as blood, serum, plasma, lymph or urine, saliva, tissue fluids, egg yolk and albumen, biological tissue parts, optically turbid liquids, soil or plant extracts as well as bio-process broths and synthetic process broths.

125. A method according to claim 122, the one or more immobilized binding partners being biological, biochemical or synthetic recognition elements for the detection of one or more analytes in one or more samples to be applied.
